(19) United States
(12) Patent Application Publication
(10) Pub. No.: US 2014/0001041 A1
(43) Pub. Date: Jan. 2, 2014

(54) BIOSENSOR

(71) Applicants: Abdur Rub Abdur Rahman, Singapore (SG); Yao-Kuang Andre Chung, Singapore (SG); Kok Chuan Lee, Singapore (SG); Shan Gao, Singapore (SG); Mi Kyoung Park, Singapore (SG)

(72) Inventors: Abdur Rub Abdur Rahman, Singapore (SG); Yao-Kuang Andre Chung, Singapore (SG); Kok Chuan Lee, Singapore (SG); Shan Gao, Singapore (SG); Mi Kyoung Park, Singapore (SG)

(73) Assignee: AGENCY FOR SCIENCE, TECHNOLOGY AND RESEARCH, Singapore (SG)

(21) Appl. No.: 13/883,969

(22) PCT Filed: Oct. 24, 2011
(86) PCT No.: PCT/SG2011/000374

§ 371 Date: Sep. 17, 2013

(30) Foreign Application Priority Data
Nov. 8, 2010 (SG) 201008260-0

(51) Int. Cl. G01N 27/327

(52) U.S. Cl. CPC G01N 27/327
USPC 204/403.01

(57) ABSTRACT

According to embodiments of the present invention, a biosensor is provided. The biosensor includes a support substrate, a plurality of sensing electrodes arranged on the support substrate, each of the plurality of sensing electrodes comprises a plurality of sensing electrode segments laterally disposed from each other, and a plurality of input-output ports configured for external connection, wherein each of the plurality of sensing electrodes is electrically isolated from each other and respectively coupled to each of the plurality of input-output ports.

### CROSS-REFERENCE TO RELATED APPLICATION

This application claims the benefit of priority of Singapore patent application No. 201008260-0, filed 8 Nov. 2010, the content of it being hereby incorporated by reference in its entirety for all purposes.

### TECHNICAL FIELD

Various embodiments relate to a biosensor.

### BACKGROUND

There are many situations in biological research and in diagnostics, where a certain type of cell is to be isolated and counted. Conventionally, optical microscopy and image analysis have been the workhorse for such measurements. A simple and label free method of doing so is via measuring the alterations in electrical impedance due to the disturbance in ionic arrangements created by the presence of a cell on its surface.

Cancer is a leading cause of death worldwide, with more than 7.6 million deaths in 2007 (American Cancer Association, 2008). It represents a tremendous burden on patients, families and societies, with long and painful therapies and remissions. Furthermore, clinicians lack the precise tools to assist them in tailoring the dosage of treatments, usually laden with potentially serious side effects (radiation, chemotherapies), for the patients. For example, conventional imaging techniques and biopsies can only detect tumors that have reached a certain size; hence it may be difficult to establish or ascertain the complete remission of the disease. Moreover, these techniques can be painfully invasive and/or costly.

In 2008, the United States Food and Drug Administration (FDA) cleared the way for a system (CellSearch™, Veridex) which reports the level of circulating tumour cells (CTCs) in metastatic breast cancer patients. CTCs are tumor cells that have detached from the primary tumor site and are circulating in the bloodstream. The number of CTCs in the blood is a clear indicator of the aggressiveness of the cancer as well as the efficacy of the therapy being applied (Pantel, K. et al., “Detection, clinical relevance and specific biological properties of disseminating tumour cells”, Nat Rev Cancer. 2008, 8(5):329-40). Hence, CTCs represent a biomarker with a potential to allow clinicians to cater therapies to specific patients and diseases as their number can be assessed in a relatively non-invasive manner, for example by blood drawing.

The detection of CTCs is generally based on the presence of the specific epithelial marker, epithelial cell adhesion molecule (EpCAM), on their surface. The technical challenge associated with the detection of CTCs lies in the fact that only a few such cells can be found in milliliters of blood, amongst millions of white blood cells and billions of red blood cells, even for patients at an advanced stage of cancer, who would be expected to have an increased number of CTCs in their bloodstream.

Conventionally, purification to isolate the CTCs is performed via complex magnetic separation steps in tubes, using beads coated with an antibody specific to the EpCAM receptor. The nature of the cells is then confirmed via fluorescent staining of cancer markers (cytokeratins for example) and lymphocytes receptors (CD45 for example) (Cristofanilli M. et al., “Circulating Tumor Cells, Disease Progression, and Survival in Metastatic Breast Cancer”, N Engl J Med. 2004, 351:781-91). The CellSearch™ system has automated this procedure into a reproducible assay. However, the procedure requires a sample transfer between two separate machines, which may cause contamination or loss of cells during the transfer. Besides, the sample even after magnetic purification, still contains a lot of other cells, necessitating a labor-intensive manual inspection of the stained cells by a trained specialist to establish the nature of the CTCs. Hence, the procedures are complex and costly, which prevent them from being used as frequent tests for therapy monitoring, although they are used for early diagnosis and prognosis.

Large volumes of blood are routinely sampled to detect various circulating cells such as endothelial progenitor cells (EPCs), CTCs and maternal fetal cells (MFCs), which may be present in numbers as low as 1 to as many as a few thousand in several milliliters. A typical work flow for detection of such rare cells involves, first, enrichment (concentration) of these cells, followed by one of several methods of detection such as optical staining and microscopy for cell enumeration and PCR for molecular analysis of the sample. The PCR-based methods are considered to be more descriptive and accurate. However, the methods have the disadvantage of a lack of quantification of cells, which is of importance. On the other hand, optical microscopy yields a good account of the cell numbers. However, this detection method has the disadvantages whereby subjectivity is involved in the interpretation of fluorescent intensities, due to cell clumping and laborious and operator intensive procedures.

Enrichment is performed in one of several ways such as immunogenic separation in which specific antibody complementary to those found on the cell surface are immobilized on a solid support which in turn is manipulated. Most commonly, magnetic particles immobilized with antibody are used. Alternatively, physical filters which selectively filter out or filter in target cells are also used. Filters may come in many forms such as micro or nanopores on a membrane. In addition, pillar type structures manufactured in silicon with micrometer separations can also be used for cell filtration. Sometimes, the channel walls and other structures may be coated with appropriate antibody for capture species immobilization.

Once the target cells have been collected, they are enumerated most commonly by staining them with specific dies and examining under a microscope. Optical staining and microscopy have been around for several decades and despite the maturity of these techniques, these methods still require skilled personnel to perform image analysis and microscopy, which are subjective.

Detection and accurate enumeration of rare circulating cells in whole blood is of tremendous importance to human health as a diagnostic, prognostic and therapy monitoring tool in a variety of health conditions such as cancer, cardiac disease, AIDS and non invasive prenatal diagnostics (NIPD). Such detection of rare cells is also important in routine biological research, for example, in stem cell enrichment. Current methods suffer from prolonged, multistep, laborious protocols which rely on cell staining and optical microscopy. These protocols are broken down into several steps, which are carried out independently, requiring extensive sample handling and transfer, which lead to cumulative effect of inefficiencies at each step.

In addition, conventionally, the flow rate of the cells has been low, which is a major bottleneck to overcome. In order to circumvent this bottleneck, in prior attempts, the sample enrichment, and pre-concentration are performed as separate steps in separate chambers followed by the flow of a small enriched sample volume through the detection chamber. However, losses of cells may occur due to sample handling, transport and transfers.

Label-free detection techniques, such as surface plasmon resonance (SPR), quartz crystal microbalance (QCM) or impedance spectroscopy, provide automation and integration to rare cell detection. These techniques can be used with either flow-through devices, similar to Fluorescence Activated Cell Sorting (FACS), or batch-based devices. Flow-through systems (Wang Y-N. et al, “On-chip counting the number and the percentage of CD4+ T lymphocytes”, Lab Chip 2008, 8, 309-315; Roeser T. et al., “Lab-on-chip for the Isolation and Characterization of Circulating Tumor Cells”, Proceedings of the 29th Annual International Conference of the IEEE EMBS, 2007, 6446-6448) are capable of individual cell detection which enables counting of cells in the sample, but these systems are laden with long processing times and also require a high purity of cells at the detection module, thereby transferring the burden to the sample preparation module to prepare high purity samples. In addition, flow-through fluidics are inefficient for large volume processing due to the long processing times and low sensitivity.

Batch-based systems enable the incorporation of a specific selection of cells inside a detection module and batch processing of samples, thus reducing the process time. However, these systems are not capable of counting cells, but merely provide semi-quantitative levels.

While the batch-based methods can process bigger volumes of samples, these are still orders of magnitude below the samples used for CTC detection. Generally, a chamber containing a microelectrode array (MEA) of 1-10 electrodes for detecting <10 CTCs, can accommodate only about 1-5 μl of sample. In addition, samples are generally transferred through pipetting or tubes, which may lead to significant loss of cells, for example unspecific adhesion of cells to the walls of the transferring apparatus or cells trapped at the connections or interfaces, which may be as high as 70% loss.

Label-free systems to detect CTCs or other rare circulating cells, such as endothelial progenitor cells (EPCs) or fetal cells, from blood, generally involve a sample preparation module (Vona G. et al., “Isolation by Size of Epithelial Tumor Cells”, American Journal of Pathology 2000, 156 (1), 57-63; S. J. Tan et al., “Microdevice for the isolation and enumeration of cancer cells from blood” Biomedical Microdevices, 2009, 11, 883-892), optionally coupled to specific staining with beads, and a flow through detector (Wang Y-N. et al, “On-chip counting the number and the percentage of CD4+ T lymphocytes”, Lab Chip 2008, 8, 309-315; Roeser T. et al., “Lab-on-chip for the Isolation and Characterization of Circulating Tumor Cells”, Proceedings of the 29th Annual International Conference of the IEEE EMBS, 2007, 6446-6448).

When the cells are trapped, for example, either magnetically (Talasaz A. H. et al., “Method and apparatus for magnetic separation of cells”, WO 2009/076560; Talasaz A. H. et al., “Isolating highly enriched populations of circulating epithelial cells and other rare cells from blood using a magnetic sweeper device”, PNAS 2009, 106 (10), 3970-3975), electrically (Chen Yu et al., “Device and method for detection of analyte from a sample”, WO2010/050898) or chemically (Tang Z L. et al., “Recovery of rare cells using a microchannel apparatus with patterned posts”, US2006/0160243 A1; Nagrath S. et al., “Isolation of rare circulating tumour cells in cancer patients by microchip technology” Nature 2007, 450, 1235-1239), the cells complexes are generally not released or at the expense of their integrity. The cells are either lysed, detected optically in the same chamber (Leary J. F. et al., “Hybrid microfluidic SPR and molecular imaging device”, WO 2009/058853), or detected using a flow-through system (Soh H S. et al., “Integrated fluidics devices with magnetic sorting”, US 2008/0302732 A1).

Electrodes have been used to detect cell adhesion, proliferation, migration and such events which involve the interaction of cells with substrates, particularly of anchorage dependent cells. Conventionally, large area electrodes, which are several times the size of a single cell are used, which yield an approximating response and it is not possible to count cells with single cell precision with these electrodes.

Electrical impedance of cells on metal electrodes has served as faithful indicator of cell-substrate interactions. This technique has been widely employed to study cell adhesion, proliferation, differentiation and metastasis, among several other cell-based interactions. Although quite prevalent for several decades, electrochemical impedance spectroscopy (EIS) has not been used to quantify cells with a single cell resolution until recently. A study by Jiang and Spencer (X. Jiang, M. Spencer, “Electrochemical impedance biosensor with electrode pixels for precise counting of CD4+ cells: A microchip for quantitative diagnosis of HIV infection status of AIDS patients”, Biosensors and Bioelectronics, 2010, 25:1622-1628), quantified 0 to 200 cells with single cell accuracy and resolution, which was the first and only report of its kind. The electrodes were designed to have small dimensions compared to substantially large electrodes (100 micron or higher single dimension) which are employed in most electrode array technology for cell-based studies, and which are unable to be resolved to single cell resolution to provide the desirable answer for the presence or absence of cells.

In the study by Jiang, cells were captured from a high concentration of cells, rather than rare cells. Furthermore, by using passive electrode array, a maximum of only 200 electrodes were achieved and the bioactive area was much less than the area of the entire chip, which is another disadvantage of the planar array. In addition, the technique was not used for flow through microfluidic capture of rare cells in a high throughput manner. Furthermore, every electrode requires a dedicated input-output (I/O) pad, hence increasing the I/O density and limiting electrode density, thereby making it impractical for large electrode arrays.

Although small electrodes are desirable from several perspectives such as high sensitivity and better resolution for cell-based studies, they also suffer from high electrode polarization, which is an inverse function of the electrode area. This means that with smaller electrodes, the electrode-electrolyte impedance becomes very high, leading to low SNR, and low sensitivity due to masking of underlying cell impedance by double layer capacitance effects. In order to overcome this, a configuration having 4 or 5 electrodes may be used. However, providing such a configuration has a drawback of reducing the electrode density for cell capture, as 4 or 5 electrodes are required to count a single cell as opposed to 2 in a typical 2 electrode setup.

Besides electrode polarization, in EIS measurements, and in particular those involving microelectrodes, the parasitic effects from long lead lines, interconnects and electrode to electrode cross talk, have a deleterious effect on the overall impedance spectrum. The parasitics could easily be confused with cell characteristics, unless carefully compensated and accounted for. Conventionally, microelectrode arrays include an array of electrodes of a specific geometry and pitch repeated over a planar surface. Interconnect wires are routed from the active electrodes to the probing pads which serve as the interface to the testing circuitry. This configuration has severe limitations. Firstly, the density of the electrodes is limited by how closely the interconnect wires can be run between electrodes. Secondly, the maximum number of electrodes is limited by the physical space available for input-output (I/O) pads for wire bonding at the periphery of the chip. Thirdly, each of these pads have to be wire bonded to a package and epoxy sealed on the top surface, which leads to additional packaging costs and a reduction in surface area available for fluidic assembly which can only be positioned on top of the active electrode area.

Furthermore, the current technology for cell enumeration using impedance with single cell precision is not suitable for high density of electrodes due to constraints in the dimensions of the electrode array, which is limited by the ability to accommodate I/Os on the periphery of the chip as well as the ability to route the interconnect lines to these I/Os, both of which are severely limiting, specifically in the case of high density electrode arrays.

Therefore, there is a need to provide a high density, large area and high performance electrode array for the detection of individual rare cells in a highly accurate, sensitive, label-free and operator independent manner, with single cell resolution, as well as a device including such an electrode array.

### SUMMARY

According to an embodiment, a biosensor is provided. The biosensor may include a support substrate; a plurality of sensing electrodes arranged on the support substrate, each of the plurality of sensing electrodes comprises a plurality of sensing electrode segments laterally disposed from each other; and a plurality of input-output ports configured for external connection; wherein each of the plurality of sensing electrodes is electrically isolated from each other and respectively coupled to each of the plurality of input-output ports.

According to an embodiment, a biosensor is provided. The biosensor may include a support substrate, the support substrate comprising a plurality of through vias arranged spaced apart from each other; a plurality of interconnect portions, each of the plurality of interconnect portions arranged within each of the plurality of through vias; and a plurality of sensing electrodes arranged on the support substrate; wherein each of the plurality of sensing electrodes is electrically isolated from each other and respectively coupled to external connection via each of the plurality of interconnect portions.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A and 1B show respectively a schematic block diagram of a biosensor, according to various embodiments.

FIGS. 2A and 2B show respectively a schematic block diagram of a biosensor, according to various embodiments.

FIG. 3A shows a schematic set-up for detecting cells using a biosensor of various embodiments.

FIG. 3B shows a schematic exploded view of the biosensor of FIG. 3A.

FIGS. 4A to 4C show schematic views of the process for flow-through, capture and detection of cells, according to various embodiments.

FIGS. 5A and 5B show schematic cross-sectional views of a biosensor, during use for enrichment and detection of cells, according to various embodiments.

FIG. 6 shows a schematic cross-sectional view of a biosensor, during use for detection of cells, according to various embodiments.

FIG. 7A shows a photograph showing a single cell occupying a sensing electrode, according to various embodiments. The scale bar represents 60 μm.

FIG. 7B shows a plot of current-voltage measurements, according to various embodiments.

FIG. 8A shows a schematic view of an array of partitioned electrodes, according to various embodiments.

FIG. 8B shows a schematic view of a partitioned electrode of the embodiment of FIG. 8A.

FIGS. 9A and 9B show schematic cross-sectional views of a respective biosensor, during use for detection of cells, according to various embodiments.

FIG. 10A shows a top view of a design of a plurality of sensing electrodes, according to various embodiments.

FIGS. 10B and 10C show optical microscope images of top views of the manufactured plurality of sensing electrodes of the embodiment of FIG. 10A. The scale bars represent 50 μm.

FIG. 11 shows a schematic top view of a plurality of sensing electrodes or sensing electrode segments, according to various embodiments.

FIG. 12A shows a plot of cyclic voltammetry measurements, according to various embodiments.

FIG. 12B shows a plot of impedance measurements, according to various embodiments.

FIG. 13 shows a schematic cross-sectional view of a biosensor including a partitioned electrode and through vias, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Various embodiments provide an integrated, single chamber enrichment and single cell accuracy enumeration of cells, for example rare circulating cells, in whole blood, without or with reduced at least some of the associated disadvantages of conventional devices. Various embodiments may provide an impedance-based approach for substantially accurate cell counting with single cell sensitivity.

Various embodiments may provide a glass or polymer based microfluidic chamber with an electrode array at the bottom of the chamber to detect and count the number of cells trapped at the electrode array within the chamber. A movable permanent magnet may be provided on the top or bottom of the chamber to trap the immuno-magnetically labeled cells in a flowing medium.

Various embodiments may provide a biosensor, a highly efficient system and a label free, operator independent, quantitative and substantially accurate technique which may enrich and enumerate cells in the least amount of time and with minimal losses. In various embodiments, the loss of cells, for example rare cells, in blood samples may be minimized by minimizing sample handling, for example via automation, and reducing the sample transfer and transport, for example by carrying out single chamber operations (e.g. performing different operations in a single chamber). Therefore, various embodiments may provide a biosensor and/or a method including enrichment or concentration of cells for example magnetically, capture of the cells and detections of the cells in the same chamber without the need to transfer the sample, for example from purification to detection chamber as in the prior art, thereby minimizing loss of cells.

Various embodiments may include one or more approaches that simultaneously target a variety of performance compromising bottlenecks in rare cell enrichment and detection. This may include (i) the use of large volume flow through enrichment for processing large volumes of whole blood containing conjugated cells with magnetic beads, (ii) the use of high density electrode array designed to capture a wide range of cells and capable of measuring with single cell accuracy, and with a substantially high electrode array density to total chip surface area ratio, and (iii) the use of polymer coatings to reduce the impedance of electrode interface and hence improve measurement performance. These approaches may be integrated into a single chamber in order to minimize the loss of rare cells due to sample handling and processing.

Various embodiments may provide a sensor (e.g. a biosensor) and a fast, simple, highly accurate, single chamber procedure to detect cells, such as rare cells, for example circulating tumour cells (CTCs), endothelial progenitor cells (EPCs) or fetal cells. In various embodiments, the cells are enriched, pre-concentrated and enumerated in a single chamber without the need for sample transfer, thereby improving efficiencies substantially. Various embodiments may provide a platform to detect rare circulating cells in a sample-to-answer integrated manner, for example for cancer therapy monitoring.

Various embodiments may provide a sensor (e.g. a biosensor), a system and/or a method that allows large volume processing of magnetically labeled cells (e.g. CTCs) in a solution of diluted white blood cells or even whole blood, in a single microfluidic chip that enables label-free detection of the cells (e.g. CTCs), thereby minimising cell loss which may occur during the sampling procedure.

Various embodiments may further provide a sensor (e.g. a biosensor), a system and/or a highly sensitive method that allows improved or substantially accurate enumeration of cells (e.g. rare cells) in the range of cell numbers between 0 to about 500000 cells, in the same chamber, with a single cell accuracy or resolution in whole blood in a high throughput manner, and a higher signal-to-noise ratio (SNR). In various embodiment, enumeration may include impedance detection of the cells (e.g. rare cells, e.g. CTCs).

In various embodiments, in order to provide detection with single cell accuracy or resolution, the dimensions of each sensing electrode of the plurality of electrodes may be sufficiently small, comparable to the dimensions of the target cells. In further embodiments, each sensing electrode may be partitioned into smaller and definitive electrode sections or segments such that each sensing electrode segment may be sufficiently small to accommodate a single cell.

Various embodiments may provide an approach providing a high electrode density whilst reducing the number of I/O ports as well as providing single cell sensitivity.

Various embodiments may provide an approach for cell counting with single cell precision by partitioning a large area electrode into smaller electrode domains or segments (e.g. electrode pixels). This may allow for cell counting with single cell precision while at the same time reducing the number of measurement contacts or I/O ports that may be needed for such a count. Therefore, by partitioning the electrodes into segments, more than one cell may be accommodated on a single electrode, whilst maintaining the ability to count the cells with single cell precision in each electrode segment or pixel. This may provide micro-pixel electrodes.

In various embodiments, the large area electrode may be partitioned into smaller domains which may be comparable to the size of a single cell of the desired cell type to be counted. Such a configuration may allow a single electrode to be used to detect or measure multiple cells with single cell precision. This may provide a high density of sensing electrodes with a high density of sensing electrode segments, with a reduced number of I/O ports. In addition, the approach of partitioning the electrodes may be combined with through vias (e.g. through silicon vias) for forming very large electrode arrays (e.g. ≧2000 electrodes).

In various embodiments, the partitions may be formed or created using an insulating film having a thickness approximately of the thickness of the target cell in its flattened state. The spacing between two such domains or segments is such that no cell may occupy the space in between these sensing electrode segments. The partitions within the single large area electrode (e.g. a single contiguous electrode) as well as the partitions between separate electrodes may be packed in a hexagonal closed packed configuration so as to yield a substantially high packing factor of the electrodes.

Various embodiments may provide a biosensor including hexagonal closed packed electrode partitioning for single cell precision cell counting with reduced number of input-output (I/O) ports. The biosensor may provide a high density low I/O hexagonal closed packed array for cell counting. This may allow a number of cells to be detected or measured with single cell precision, while connected to the measurement circuitry through a single I/O port. The measurement circuitry may be provided on a chip or integral to a chip with the biosensor or external to the chip with the biosensor. Multiple electrode segments may be addressed using a single I/O port. The number of such partitions on one electrode is only limited by the resolution (e.g. accuracy and noise performance) of the measurement instrument such that the number of target cells to a single I/O port is only limited by the resolution of the measuring instrument, whilst enabling single cell resolution.

Various embodiments may provide a method to flow whole blood containing immune-magnetically labeled rare cells in and through a large volume microfluidic chamber, followed by selective magnetic entrapment, via application of a magnetic field (e.g. using a magnet) of the rare cells, being the target cells, and disposal or filtering of non-target cells, which are not magnetically labeled. The rare cells may then be substantially accurately enumerated in the same chamber by releasing them from the influence of the magnetic field. In various embodiments, the whole blood may be flowed through under high flow rates. In various embodiments, a size-based filter may not be needed as the target cells may be captured under the influence of the magnetic field. In various embodiments, a size-based filter may be integrated on the roof of the chamber, thus allowing enrichment of cells based on the size, followed by their enumeration in the same chamber.

Various embodiments may include the use of an external magnet (e.g. a permanent magnet) with flow-through of the cells under the influence of the magnetic field of the magnet and may include the integration of an impedance detection unit (e.g. in the form of an array of sensing electrodes or sensing electrode segments) in the same flow field.

In various embodiments, whole blood sample may be collected from patient in varying quantities ranging from about 1 ml to about 40 ml. The blood sample may then be incubated with magnetic beads (e.g. nanomagnetic beads) coated with an appropriate antibody, complementary to the antigens found on the target cells. Upon incubation, for example to bind the magnetic beads to the target cells, the sample may be flowed through a microfluidic chamber. The chamber may have a bottom surface populated with a plurality or array of sensing electrodes or sensing electrode segments, having sufficiently small dimensions to detect a single cell, and positioned sufficiently close so as to prevent or minimize the possibility of a cell being located in the “dead space” between the sensing electrodes, where detection or measurements of the cells may not be possible.

Subsequently, magnetic trapping of the immunomagnetically labeled cells is performed by lowering a magnet or positioning a magnet (e.g. a permanent magnet) in the vicinity of the ceiling of the chamber while flowing the sample through the chamber, thereby adhering or trapping the immunomagnetically labeled cells on or close to the chamber ceiling. After the sample has been flowed through the chamber, the magnet may be lifted or removed from position, thereby allowing the immunomagnetically labeled cells to settle on the bottom surface populated with the high density of sensing electrode array. Once settled, the cells may interact and conjugate with the antibody on the surface of the array of sensing electrodes. Impedance measurements may be performed to differentiate between the presence and absence of cells on each sensing electrode or sensing electrode segment of the array of sensing electrodes, by which the cells may be counted. An optical sensor or device may also be placed in the chamber for visual inspection of the cells.

In various embodiments, various types of antibody coated beads may be flowed sequentially for multiplexed detection, thereby providing a versatile biosensor and system for detecting a wide range of cell types in blood samples applicable to a variety of health conditions.

Various embodiments may provide a large area array of sensing electrodes (i.e. an array or plurality of sensing electrodes or sensing electrode segments covering a large area of the sensor or system), which when integrated with microfluidics may allow for high flow rates, for example of cells flowing through the sensing electrodes in the sensor or system.

Various embodiments may include interconnect portions, with an approach of routing the interconnect portions through the bulk of the substrate material (e.g. silicon substrate). This may allow a reduction in parasitic effects, a higher density of input-output (I/O) ports and a reduction in the complexity and cost of packaging, for example of the biosensor and system. This may be achieved by providing through vias (e.g. through silicon vias) and providing the interconnect portions within or through the through vias. Through vias may allow for high density and large area array of sensing electrodes, which otherwise may not be possible with conventional passive electro assembly. In other words, through vias may allow a higher density of sensing electrodes or sensing electrode segments to be provided. In various embodiments, measurements of cells on the sensing electrodes or sensing electrode segments may be performed by an offchip measurement unit or circuit or by electronics or measurement circuit integrated or built in on the chip with the biosensor.

Various embodiments may provide a microfluidic integrated electrical biosensor with a sensing electrode array, where no wirebonding or packaging is used to connect the sensing electrodes to the supporting electronics, e.g. measurement electronics.

Various embodiments may provide a microfluidic integrated biosensor with an integrated demultiplexer and measurement electronics, such that the electrical signal path between the biosensing region (e.g. the sensing electrodes) and the measurement electronics may be sufficiently short, for example less than about 1 mm.

Various embodiments may provide an approach where the biosensing electrodes may or may not be permanently attached to the fluidic assembly. In various embodiments, the supporting measurement electronics may be coupled to the biosensing electrodes using techniques such as wire bonding, whilst maintaining the shortest distance between the bioactive sensing region and the electrical probing contact point, thereby reducing the parasitic. Therefore, in various embodiments, the supporting measurement electronics is not permanently attached or coupled to the biosensing electrodes, but may be flexibly removed.

Various embodiments may provide a microfluidic integrated electrical biosensor with a sensing electrode array, without a permanent contact between the sensing electrodes and the measurement electronics or external electronics, whilst maintaining a microfluidic architecture having a substantially short distance between the biosensing electrodes and the electrical probing points in order to reduce measurement parasitics.

Various embodiments may provide an approach of achieving high electroactive-silicon/total silicon area and bioactive-silicon/total silicon area and electroactive-silicon area/microfluidic flow ratio with the shortest distance to electrode probe contact pads.

Various embodiments may provide a method of impedance imaging of a high density substrate to discriminate between cell types in a heterogeneous cell population.

Various embodiments may provide substantially precise cell counting, a reduction in the number of I/O ports and the packaging requirements, a cost-effective approach and an improved performance, for example reduced parasitics due to the separation between measuring electrodes, for example the working electrodes (WE) and the counter electrode (CE).

Various embodiments may provide detection of rare cells in blood/media based on specific antibodies. Various embodiments may include biomarker panel detection capabilities with selective immobilization of probes.

Various embodiments may provide an electrical/electrochemical sensor array for detection of cells from body fluids and/or tissue samples for diagnosis and monitoring purpose, for example CD4+ T lymphocytes for HIV, EPCs for cardiovascular related disease, and CTCs for cancer, detection of pathogenic bacteria, for example E. coli O157: H7 and Salmonella in water/media/solutions, detection of contaminants in water such as heavy metals, and detection of panel of biomarkers from bodily fluids using immuno-histochemistry or nucleic acids or proteins. Various embodiments may also provide a sensing/manipulation array for simultaneous simulation and recording from excitable cells.

Various embodiments of the biosensor and system may also be used for cell culture followed by cell enumeration, cell adhesion and proliferation, cell drug interaction, cell signaling pathways, cell lysis followed by cell enumeration and subsequent PCR, and stimulation and recoding of electrogenic cells such as neural and cardiac cells, with or without any modifications or adaptations.

In order that the invention may be readily understood and put into practical effect, particular embodiments will now be described by way of examples and not limitations, and with reference to the figures.

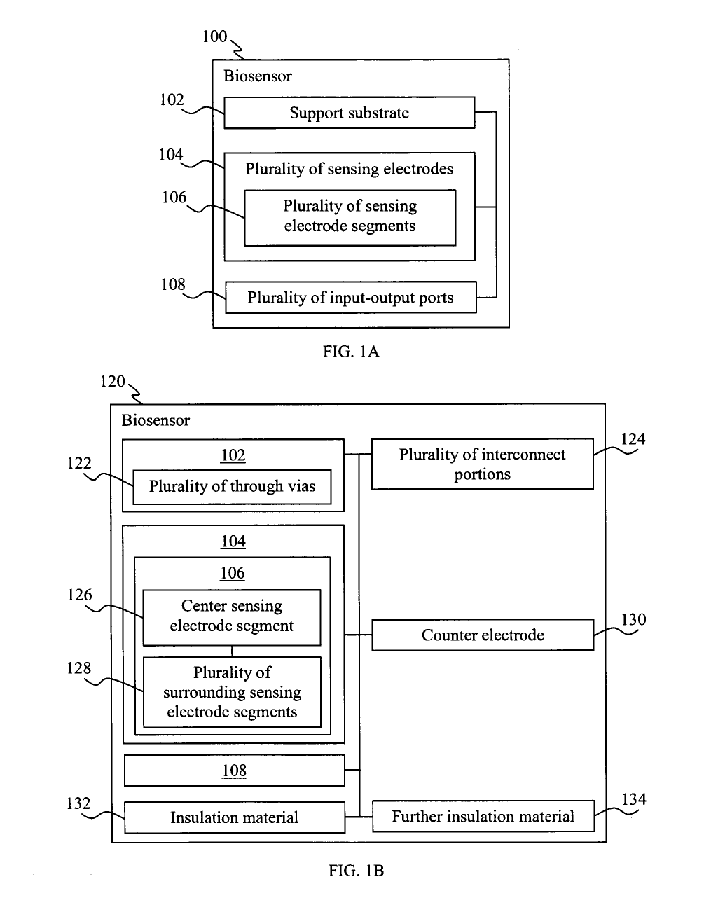

FIG. 1A shows a schematic block diagram of a biosensor 100, according to various embodiments. The biosensor 100 includes a support substrate 102, a plurality of sensing electrodes 104 arranged on the support substrate 102, each of the plurality of sensing electrodes 104 comprises a plurality of sensing electrode segments 106 laterally disposed from each other, and a plurality of input-output ports 108 configured for external connection, wherein each of the plurality of sensing electrodes 104 is electrically isolated from each other and respectively coupled or couplable to each of the plurality of input-output ports 108.

FIG. 1B shows a schematic block diagram of a biosensor 120, according to various embodiments. The biosensor 120 includes a support substrate 102, a plurality of sensing electrodes 104 arranged on the support substrate 102, and a plurality of input-output ports 108, which may be similar to the embodiment as described in the context of FIG. 1A.

In the biosensor 120, the support substrate 102 includes a plurality of through vias 122 arranged spaced apart from each other.

The biosensor 120 may further include a plurality of interconnect portions 124, each of the plurality of interconnect portions 124 may be arranged within each of the plurality of through vias 122. Each of the plurality of sensing electrode segments 106 may be electrically coupled to each of the plurality of interconnect portions 124.

In various embodiments, each of the plurality of sensing electrode segments 106 may be shaped to trap an individual target molecule. Each of the plurality of sensing electrode segments 106 may be dimensioned to provide space for an individual target molecule. Each of the plurality of sensing electrode segments 106 may include a shape selected from a group of shapes consisting of triangle, square, pentagon, hexagon and octagon. However, it should be appreciated that each of the plurality of sensing electrode segments 106 may have any polygonal shape. In various embodiments, each of the plurality of sensing electrode segments 106 may be arranged in a predetermined arrangement so as to optimize packing density of the plurality of sensing electrode segments 106 within each of the plurality of sensing electrodes 104.

In various embodiments of the biosensor 120, the plurality of sensing electrode segments 106 include a center sensing electrode segment 126 and a plurality of surrounding sensing electrode segments 128 configured to surround the center sensing electrode segment 126.

The biosensor 120 may further include a counter electrode 130 disposed above or in the same plane as that of the plurality of sensing electrodes 104, such that when a voltage is applied between the plurality of sensing electrodes 104 and the counter electrode 130, an electric field is created therewithin to allow the counting of individual target molecule.

In various embodiments, an insulation material 132 may be provided between each of the plurality of sensing electrodes 104. A further insulation material 134 may be provided between each of the plurality of sensing electrode segments 106. The further insulation material 134 may be of the same material as the insulation material 132.

In various embodiments, the further insulation material 134 may extend from a surface of the support substrate 102 or from a surface of each of the plurality of sensing electrodes 104 such that an individual target molecule may be positioned within each of the plurality of sensing electrode segments 106.

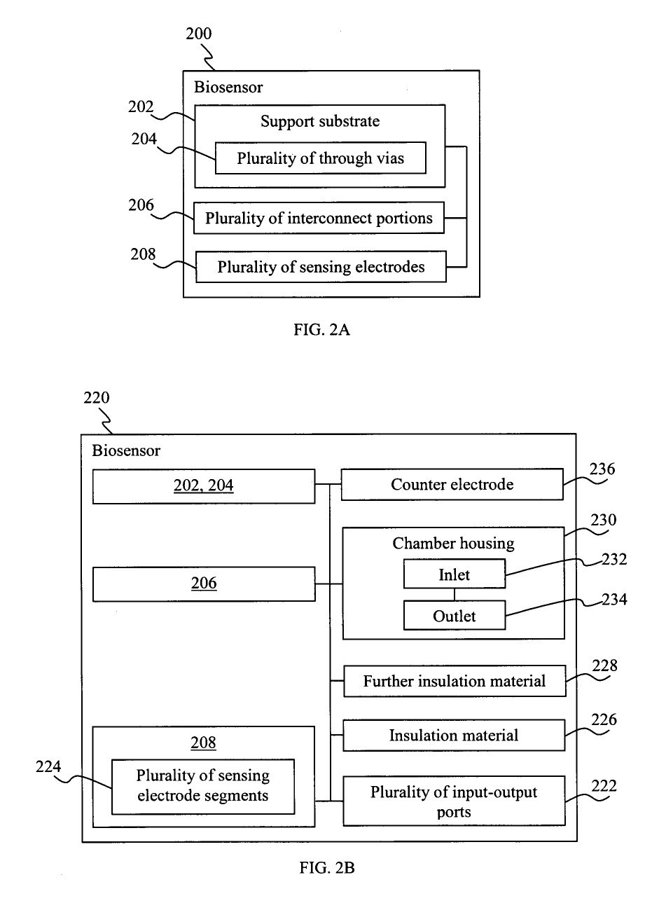

FIG. 2A shows a schematic block diagram of a biosensor 200, according to various embodiments. The biosensor 200 includes a support substrate 202, the support substrate 202 including a plurality of through vias 204 arranged spaced apart from each other, a plurality of interconnect portions 206, each of the plurality of interconnect portions 206 arranged within each of the plurality of through vias 204, and a plurality of sensing electrodes 208 arranged on the support substrate 202, wherein each of the plurality of sensing electrodes 208 is electrically isolated from each other and respectively coupled or couplable to external or on-chip connection via each of the plurality of interconnect portions 206.

FIG. 2B shows a schematic block diagram of a biosensor 220, according to various embodiments. The biosensor 220 includes a support substrate 202 including a plurality of through vias 204, a plurality of interconnect portions 206, and a plurality of sensing electrodes 208 arranged on the support substrate 202, which may be similar to the embodiment as described in the context of FIG. 2A.

The biosensor may further include a plurality of input-output ports 222 configured for the external connection, wherein each of the plurality of sensing electrodes 208 may be respectively coupled to each of the plurality of input-output ports 222.

In various embodiments, each of the plurality of sensing electrodes 208 includes a plurality of sensing electrode segments 224 laterally disposed from each other.

In various embodiments, an insulation material 226 may be provided between each of the plurality of sensing electrodes 208. A further insulation material 228 may be provided between each of the plurality of sensing electrode segments 224. The further insulation material 228 may be of the same material as the insulation material 226.

The biosensor 220 may further include a chamber housing 230 formed over the support substrate 202, the chamber housing 230 having an inlet 232 and an outlet 234.

The biosensor 220 may further include a counter electrode 236 disposed on a surface of the chamber housing 230 spaced apart from the support substrate 202.

In various embodiments, the insulation material 226 may extend from a surface of the support substrate 202 such that that an individual target molecule may be positioned within each of the plurality of sensing electrodes 208.

In various embodiments, the further insulation material 228 may extend from a surface of the support substrate 202 or from a surface of each of the plurality of sensing electrodes 208 such that an individual target molecule may be positioned within each of the plurality of sensing electrode segments 224.

In various embodiments, each of the plurality of sensing electrodes 208 or each of the plurality of sensing electrode segments 224 may be dimensioned to provide space for an individual target molecule.

In the context of various embodiments, the insulation material (e.g. 132, 226) may include one or a combination of materials selected from a group consisting of silicon nitride (Si₃N₄), silicon dioxide (SiO₂), any other insulating dielectrics or any other insulating polymers, e.g. epoxy resins.

In the context of various embodiments, the counter electrode (e.g. 130, 236) may be made of noble metal or indium titanium oxide.

In the context of various embodiments, the support substrate (e.g. 102, 202) may include a semiconducting substrate or an insulating substrate.

In the context of various embodiments, each of the plurality of sensing electrodes (e.g. 104, 208) includes a surface coated with a molecule capable of specifically binding an individual target molecule and/or a conducting polymer.

In the context of various embodiments, the target molecule may be a biological cell or a virus or a subcellular component. The subcellular component may be selected from the group consisting of a fragment of a membrane or an organelle. The biological cell may be a pathogen. The biological cell may be a prokaryotic or eukaryotic cell. The eukaryotic cell may be a mammalian cell, preferably a cell of human origin.

In the context of various embodiments, the target molecule may be a biological cell which may be found in blood of animals. The biological cell which may be found in blood of animals may be selected from the group consisting of erythrocyte, leukocyte, circulating tumor cell (CTC) and fetal cells.

In the context of various embodiments, the target molecule may be a pathogen.

In the context of various embodiments, the molecule capable of specifically binding an individual target molecule may be an antibody or an anticalin.

In the context of various embodiments, the molecule capable of specifically binding an individual target molecule may be a binding fragment of an antibody selected from the group consisting of F(ab′)2, Fab, scFv, Fv, and dAb.

In the context of various embodiments, the conducting polymer may be selected from the group consisting of poly(3,4-ethylenedioxythiophene) and its derivatives, polythiophene and its derivatives, polypyrrole and its derivatives, polyaniline and its derivatives, polyacetylene and its derivatives, poly(para-phenylenevinylene) and its derivatives, polypyridine and its derivatives, polyfluorene and its derivatives, polyindole and their derivatives, polyazines and their derivatives, polyparaphenylenes and their derivatives, poly-p-phenylene sulfides and their derivatives, polyselenophene and their derivatives, and mixtures of said conducting polymers.

In the context of various embodiments, the term “target cell” may mean a cell that is of interest, and which is to be detected and counted. Correspondingly, the term “non-target cell” may mean a cell that is not of interest and which may be removed from a sample. In the context of various embodiments, the term “target cell” may include “target molecule”.

In the context of various embodiments, the terms “input-output port” or “(I/O) port” may mean a port for connection to an external device, for example a processing device, where input signals and/or output signals may be communicated via the I/O port.

In the context of various embodiments relating to magnetically labeled cells, the cells may be labeled with magnetic beads, for example attaching one or more magnetic beads to a target cell. The cells may be magnetically labeled with the magnetic beads prior to flowing the sample through the sensor or system. Therefore, the pre-conjugated cells is flowed through the chamber of the sensor or system, thereby allowing substantially faster flow rates in a single step process.

In the context of various embodiments of the array of sensing electrodes, the dimensions of each sensing electrode or the dimensions of each sensing electrode segment of an sensing electrode may have dimensions sufficiently small, comparable to the dimensions of the cells of interest, so as to allow single cell detection and to receive a “binary” answer for the presence (e.g. a positive response or state) or absence (e.g. a negative response or state) of a single cell in each sensing electrode or sensing electrode segment. In various embodiments, cell counting may then be performed by summing the sensing electrodes or sensing electrode segments exhibiting a positive response or state, i.e. captured with a single cell.

In the context of various embodiments, each of the plurality of sensing electrodes may be provided or coated with a biological capture agent such as an antibody, complementary to the antigens found on the specific target cells, in order to capture the target cells. In addition, the electrodes may be individually immobilized with different antibodies so as to produce a highly multiplexed assay for detection. In other words, different individual sensing electrodes may be coated with different antibodies.

In the context of various embodiments, each of the plurality of sensing electrodes or sensing electrode segments may be configured as or configured to function as a working electrode.

In the context of various embodiments, each of the plurality of sensing electrodes or sensing electrode segments may be formed via lithography.

In the context of various embodiments, the array or plurality of sensing electrodes may be a microelectrode array including individual sensing electrodes or sensing electrode segments with a dimension comparable to the size of the target cell. Each individual sensing electrode or sensing electrode segment may be used or operated individually or in groups or clusters with electronic addressing schemes.

In the context of various embodiments, each sensing electrode or each sensing electrode segment of a partitioned sensing electrode may have a size in a range of between about 100 nanometer (nm) and about 1000 micrometer (μm).

In the context of various embodiments, the electrode-to-electrode spacing between adjacent sensing electrodes may be in a range of between about 500 nm and about 1000 μm.

In the context of various embodiments, the electrode segment-to-electrode segment spacing of a partitioned sensing electrode may be in a range of between about 50 nm and about 100 μm.

In the context of various embodiments, a reference to a sensing electrode may include a reference to a sensing electrode segment of a partitioned sensing electrode.

In the context of various embodiments, the through vias may have dimensions of about 50 nm and about 100 μm.

In the context of various embodiments, the through vias may be through silicon vias (TSVs) when the support substrate or the material of the substrate is silicon.

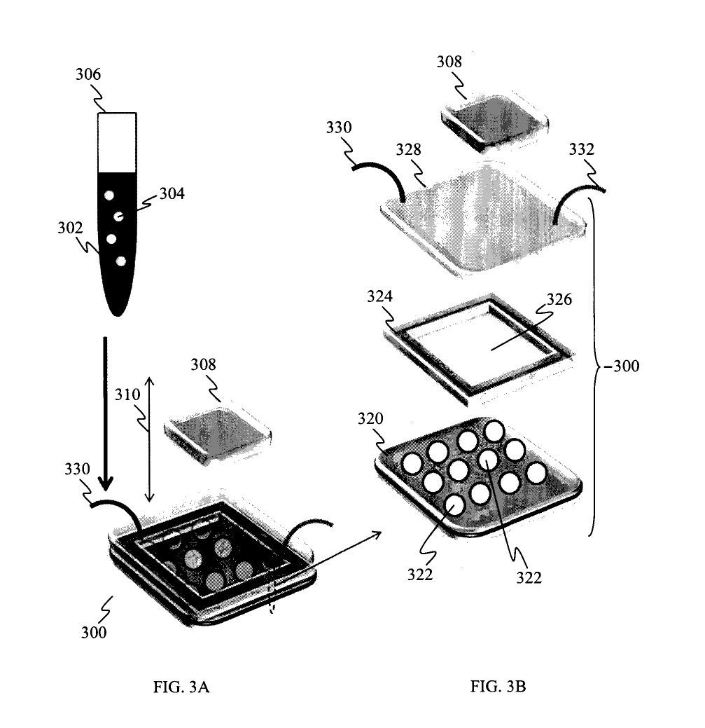

FIG. 3A shows a schematic set-up for detecting cells using a biosensor 300 of various embodiments. In various embodiments, a blood sample containing rare cells (e.g. CTCs, which are the target cells)) to be detected may be incubated with magnetic beads immobilized on the cells with antibody, for about 2 hours. The magnetic beads may be antibody-linked magnetic beads (ie. magnetic beads coupled with antibody) for coupling to the target cells. In the following descriptions relating to FIGS. 3A and 3B, as an example and not limitations, the target cells are circulating tumour cells (CTCs).

As shown in FIG. 3A, the blood sample (e.g. whole blood) 302 containing CTCs conjugated or labeled with magnetic beads, as represented by 304 for one such conjugated CTC, may be provided, for example, in a pipette 306 for transfer to the biosensor 300 for cell detection. The pipette 306 may then be coupled or connected to the inlet 330 of the biosensor 300 so that the sample 302 may flow through the large fluidic chamber of the biosensor 300. In various embodiments, the sample 302 may include non-target cells (not shown).

FIG. 3B shows a schematic exploded view of the biosensor 300 of FIG. 3A, to illustrate the various parts for the assembly of the biosensor 300. The biosensor 300 includes a chamber bottom portion 320 including a high density array of sensing electrodes, as represented by 322 for two sensing electrodes, incorporating through silicon via (TSV) for interconnections. Therefore, the chamber bottom portion 320 includes a TSV sensing electrode array. The chamber bottom portion 320 may be a support substrate for the biosensor 300. Each sensing electrode 322 may be coated with an antibody (not shown) for capturing the magnetically labeled CTCs 304 and/or a conducting polymer (not shown).

The biosensor 300 further includes a gasket 324. The gasket 324 includes a well or chamber 326, which when the gasket 324 is placed over the chamber bottom portion 320, the chamber 326 allows the array of sensing electrodes 322 to be exposed through the chamber 326. This allows the sample 302 to be received in the chamber 326 and over the array of sensing electrodes 322, for trapping and detection of target cells within the chamber 326.

The biosensor 300 further includes a chamber top or chamber housing 328, which may form the ceiling of the chamber 326. The chamber housing 328 includes an inlet 332 through which the sample 302 containing the magnetically labeled CTCs 304 may flow into the chamber 326, and an outlet 334 through which the sample 302, substantially without the target CTC cells 304, may flow out of the chamber 326 as waste. The chamber housing 328 or the roof of the chamber housing 328 may be made of a polymeric material.

In various embodiments, the fluidic chamber 326 of the biosensor 300 is subjected to a magnetic field from a magnet (e.g. a permanent magnet) 308 positioned above and/or over the ceiling of the chamber 326. In other words, the magnet 308 may be positioned above and/or over the chamber housing 328. The magnet 308 may be moved relative to the ceiling of the chamber 326, for example in an upward or a downward direction as represented by the arrow 310.

In various embodiments, the use of a gasket-based assembly allows for easy assembly and disassembly of the trapping/detection chamber. This may facilitate, for example, easy exchange of the array of sensing electrodes with different antibody-coated electrode array for multiplexed detection.

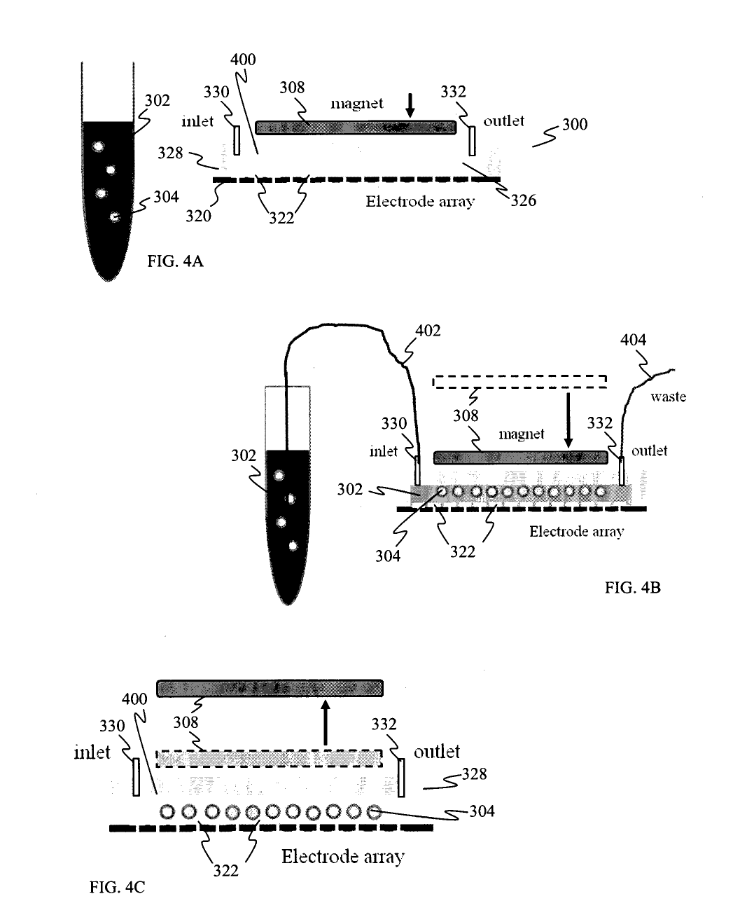

The process of flowing the sample 302, containing magnetically labeled CTCs 304 and additionally non-target cells, to the biosensor 300 of various embodiments, trapping and capturing the CTCs 304 for detection, are now described with reference to FIGS. 4A to 4C. It should be appreciated that for clarity and illustration purposes, the size of the magnetically labeled CTCs 304 are exaggerated in FIGS. 4A to 4C, and illustrated as bigger than the diameters of the tubes 402, 404, the inlet 330 and the outlet 332, for example.

In addition, for clarity and illustration purposes, the gasket 324 and the chamber housing 328 as shown in FIG. 3B are collectively illustrated as chamber housing 328 in FIGS. 4A to 4C. Alternatively, the chamber housing 328 may have the shape or configuration of an inverted ‘U’ with flat top surfaces. In other words, the chamber housing 328 may have substantially central planar surfaces with respective side walls protruding at either end of the planar surfaces such that when the chamber housing 328 is placed on or over chamber bottom portion 320, the chamber 326 is formed by the chamber bottom portion 320 and the chamber housing 328, as shown in FIG. 4A.

FIG. 4A shows an embodiment of an initial set-up, including the sample 302 containing magnetically labeled CTCs 304, and the biosensor 300. The magnet 308 may be placed over the chamber housing 328 close to the chamber ceiling 400, as shown in FIG. 4A, or may be moved into a position close to the chamber ceiling 400, as shown in FIG. 4B, when the sample 302 is flowed into the chamber 326 of the biosensor.

As shown in FIG. 4B, the sample 302 containing magnetically labeled CTCs 304 may be flowed into the chamber 326 via, for example a tube 402 connecting between the sample 302 and the inlet 330. Whilst the sample 302, containing the magnetically labeled CTCs 304 and additionally non-target cells, is flowing through the chamber 326 of the biosensor 300, the magnet 308 may be lowered towards the ceiling wall 400 of the chamber 326 so as to be positioned near or in the vicinity of the chamber ceiling 400 such that the chamber 326 is subjected to a substantially maximum magnetic field influence. This may lead to attraction of the magnetic bead labeled or coated CTCs 304 by the magnet 308 such that the CTCs 304 may adhere or are trapped to the ceiling 400 of the chamber 326. Therefore, the CTCs 304 are captured within the chamber 326. As the sample 302 flows through the chamber 302, the remaining sample 302 containing non-target cells and substantially without the target CTC cells 304, may flow out of the chamber 326 as waste through the outlet 332 and via, for example the tube 404 connected to the outlet 332.

After the sample 302 has flowed through, a buffer (e.g. phosphate buffered saline (PBS)) may be flowed through, via the inlet 330, for a few seconds to wash and clean the chamber 326, and out of the chamber 326 via the outlet 332.

Subsequently, as shown in FIG. 4C, the magnet 308 may be moved away from the chamber ceiling 400, for example lifted to a distance above the chamber housing 328 so as to reduce the influence of the magnetic field of the magnet 308 within the chamber 326. This leads to the release of the CTCs 304 from the ceiling 400, where the CTCs 304 then settle at the bottom of the chamber 326 on the chamber bottom portion 320, which includes the array of sensing electrodes 322. Each sensing electrode 322 may be coated with antibody (not shown) such that the released CTCs 304 may be immobilized onto the array of sensing electrodes 322 by the antibody.

After a few minutes of incubation time, the CTCs 304 bind to the antibody-coated electrode surface, leading to a change in impedance. Detection and enumeration of the CTCs 304 may then be performed.

In various embodiments, as the array of sensing electrodes 322 does not necessarily require packaging, the chamber bottom portion 320 with the array of sensing electrodes 322 may be easily disposed off or subject to stringent cleaning and reuse protocols, that may not be possible or compatible with conventional polymer encapsulated and wire bonded electrode array chips.

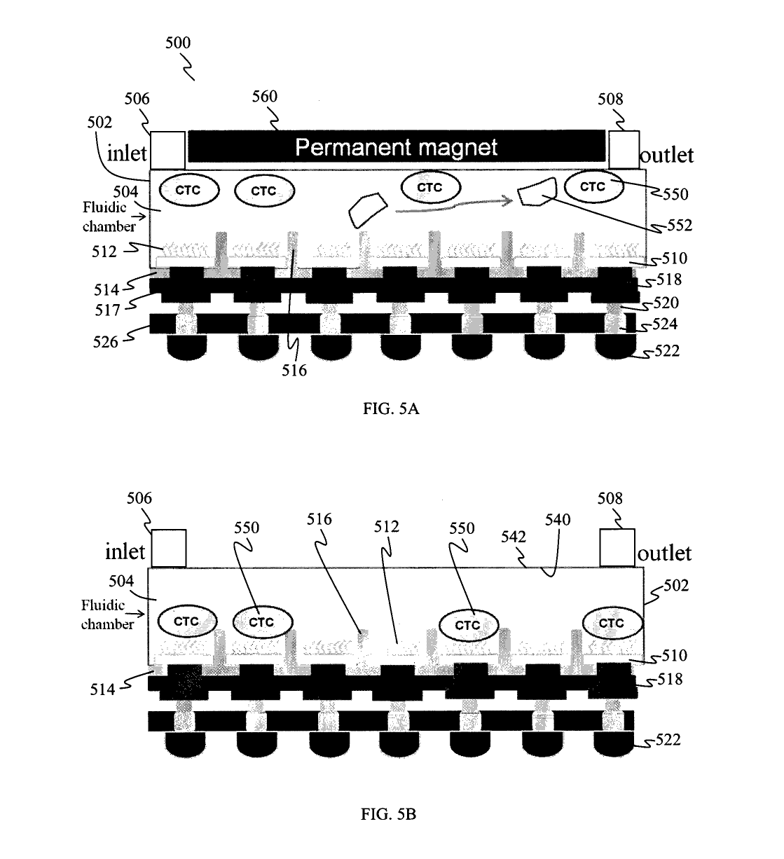

FIGS. 5A and 5B show schematic cross-sectional views of a biosensor 500, during use for enrichment and detection of cells, according to various embodiments.

It should be appreciated that the descriptions of features of the biosensor 300 in the context of FIGS. 3A to 3B and 4A to 4C may be applicable to corresponding features of the biosensor 500 and therefore may not be repeated here with respect to the biosensor 500. In addition, it should be appreciated that the descriptions of the process of flowing through the sample and enriching and capturing the target cells in the context of FIGS. 4A to 4C may be applicable correspondingly to similar process for the biosensor 500 and therefore may not be repeated here with respect to the biosensor 500.

The biosensor 500 may include a chamber housing 502 forming a fluidic chamber 504, the chamber housing 502 including an inlet 506 and an outlet 508. The biosensor 500 may further include a high density array or plurality of sensing electrodes, as represented by 510 for one sensing electrode, provided at the bottom of the chamber 504. Each sensing electrode 510 may include an antibody 512 coated on a surface of the sensing electrode 510. While not shown, each sensing electrode 510 may include a conducting polymer coated on a surface of the sensing electrode 510 in addition to or alternative to the antibody 512.

The plurality of sensing electrodes 510 may be a microelectrode array including individual electrodes of a size comparable to that of the cell being detected. Each individual sensing electrode 510 forms a respective working electrode, which may be used individually or in groups or clusters with electronic addressing schemes.

The biosensor 500 may further include a counter electrode (not shown) disposed on a surface of the chamber housing 502, for example on an inner surface or ceiling wall 540 of the chamber housing 502, or formed through the thickness of the chamber housing 502 from the ceiling wall 540 to the outer surface 542 of the chamber housing 502. Therefore, the counter electrode may be positioned above the plurality of sensing electrodes or working electrodes 510. The counter electrode may be made of noble metal or indium titanium oxide, which is a conducting and transparent material, thereby facilitating electrical conductivity for impedance measurements as well as transparency for optical measurements.

In various embodiment, the counter electrode is placed out of the plane of the working electrodes or sensing electrodes 510 so as to avoid the electric field lines coupling through the substrate as well as current escaping from underneath the target cells, thereby leading to measurement ambiguity. In addition to the counter electrode, a reference electrode (not shown) may also be provided.

The plurality of sensing electrodes 510 may be formed on an insulation material (e.g. a layer of insulator or insulation material, e.g. a layer of silicon nitride (Si₃N₄)) 514, with insulator walls 516 of the insulation material 514 being provided between adjacent sensing electrodes 510 to provide electrical isolation among the sensing electrodes 510. The layer of insulation material 514 may be a support substrate of the biosensor 500. In further embodiments, the walls 516 of insulation material may be formed on the insulation material layer 514. In other words, the walls 516 may not be part of the insulation material layer 514. The insulation material of the walls 516 and the layer 514 may be the same or different. The insulation material may include but is not limited to silicon nitride, silicon dioxide or insulating polymers.

In various embodiments, the layer of insulation material 514 may be provided on a layer of interposer 517.

The biosensor 500 may include a plurality of through vias, as represented by 518 for one through via, coupled to the plurality of sensing electrodes 510. The plurality of through vias 518 may be spaced apart, as shown in FIGS. 5A and 5B, corresponding to the plurality of sensing electrodes 510. The plurality of through vias 518 may be formed through the insulation material layer 514 and the interposer layer 517.

An interconnect portion may be provided or arranged within each through via 518, for example by depositing a metal (e.g. gold), as via filling, within each through via 518, such that a respective through via 518 with the interconnect portion, may be in electrical communication with a respective sensing electrode 510. Therefore, a plurality of interconnect portions may be provided, which may allow for coupling to external connections. It should be appreciated that other metals, including but not limited to copper, aluminum and nickel, may also be used for the via filing.

In various embodiments, each sensing electrode 510 may be coupled to an input-output (I/O) port configured for external connections (i.e. connections to external circuits or devices) such that a plurality of I/O ports may be provided.

In various embodiments, each through via 518 may be provided with a solder bump 520. Each solder bump 520 may be electrically coupled to a flipchip bump 522 through a respective through via 524 formed through another interposer layer 526.

In various embodiments, the layer of insulation material 514, the interposer layers 517, 526, may be bulk silicon without active circuitry, or may include active circuitry to address the array of sensing electrodes 510, to amplify and/or condition the signal obtained from the detection process and/or to perform various electrochemical measurements such as impedimentary, potentiometry and coulometry, among others. In various embodiments, the electrode addressing circuitry and the impedance measurement circuitry may be formed at least substantially directly beneath the array of sensing electrodes 510 and connected to the sensing electrodes 510 via the through vias 518. This may reduce the distance between the electrical routing lines, thereby improving the performance of the biosensor.

When in use for enrichment and detection of cells, a sample containing immune-magnetically labeled cells (e.g. CTCs with magnetic beads), i.e. target cells 550, and non-target cells 552, may be flowed into the fluidic chamber 504 via the inlet 506. During the flow-through of the sample, a permanent magnet 560 may be lowered to just above the chamber housing 502 so as to capture the target cells 550 and immobilise the target cells 550 to the chamber ceiling 540, as shown in FIG. 5A. During the flow-through, non-target cells 552 (e.g. non-CTCs) may be washed away and removed from the chamber 504 as waste via the outlet 508.

Subsequently, the permanent magnet 560 is removed, thereby releasing the target cells 550 onto the array or plurality of sensing electrodes 510 for label free enumeration of the target cells 550, as shown in FIG. 5B. Each target cell 550 may be immobilised by the antibody 512, capable of specifically binding the individual target cell 550, on a sensing electrode 510 thereby allowing single cell detection.

In various embodiments, in order to detect cells (e.g. rare cells such as CTCs), with single cell resolution using impedance, and assuming no cell clumping or clustering and that the total number of target cells to be detected is lower than the number of electrodes, the plurality of sensing electrodes of various embodiments may be designed based on one or more of the following considerations: (i) the size of each sensing electrode is comparable to the size of the cell being detected (i.e. target cell), (ii) the electrode-to-electrode separation is sufficiently small, and substantially smaller than the size of the sensing electrode, so as to minimise the probabilities that any of the target cells may entirely or partially occupy a “dead space” or an un-measurable space between the sensing electrodes, and/or (iii) each sensing electrode is provided in a recess so as to substantially fully contain a single cell in the recess (e.g. the area around each sensing electrode may be provided with protrusions or walls substantially surrounding each sensing electrode in order to form a recess having the sensing electrode, such that a single cell may fit in the recess).

In various embodiments, a decrease in the size of the electrode may lead to an increase in impedance, as a result of the inverse dependence of the interfacial capacitance to the surface area. In the case of microelectrodes, this impedance may affect the noise performance and accuracy of the measuring instruments. In various embodiments, surface treatments such as pyrrole polymerization or platinization may be performed on the electrode to reduce the electrode interfacial impedance, for example by about 2-3 orders of magnitude. In various embodiments, conducting polymers such as polypyrrole may be used. Conducting polymer whose end is functionalized to react and conjugate with antibody may also be used. This serves the dual purpose of reducing the interfacial impedance, improving the accuracy and noise performance of the measurements as well as providing specificity of the antibody.

In addition, in various embodiments, the fluidic chamber may be tailored to accommodate various flow rates of the sample through the chamber and capacities of the chamber, based on one or more of the following considerations, which are that substantially the entirety of the chamber floor may be occupied by the plurality of electrodes so as to improve the probabilities of capturing the target cells, and that the flow rate through the chamber may be provided such that the fluidic drag force on the magnetically labeled target cells is less than the magnetic force acting on the magnetic beads attached to the target cells due to the permanent magnet or electromagnet.

Measurements performed show that a flow rate of about 100 μl/min may allow the capture of about 80% of CTCs from a blood sample. However, it should be appreciated that other flow rates may be used, for example a flow rate in a range of between about 5 μl/min and about 5000 μl/min, for example a range of between about 150 μl/min and about 800 μl/min or a range of between about 300 μl/min and about 500 μl/min. The flow rate used and/or the percentage of cells captured may depend on one or more of the following: (i) the mass, volume and size of the target cell, (ii) the expression of targeted antigen on the surface of the target cell, (iii) the size, magnetic properties and the geometry of the magnetic beads attached to the target cell and (iv) the viscosity of the medium or blood sample.

Therefore, in various embodiments, a wide range of electrode configurations and fluidic chamber configurations may be provided, thereby allowing design flexibility.

In addition, upon capturing of the target cells using the magnetic field and release of the target cells onto the plurality of electrodes, the fluid or sample inside the chamber may be gently oscillated by external pumping to allow uniform distribution of the target cells over the sensing electrodes, or by continually rotating the magnet about its axis to achieve the same effect.

In various embodiments, a size filter may be arranged or integrated on the roof of the biosensor, e.g. on the roof or ceiling wall 540 of the chamber housing 502, allowing the cells to be filtered on the chamber roof. The cells may thereafter be settled on the plurality of sensing electrodes 510 by backflow for enumeration of the cells. This may allow capture of cells based on size in addition to or as an alternative to magnetic bead based capture.

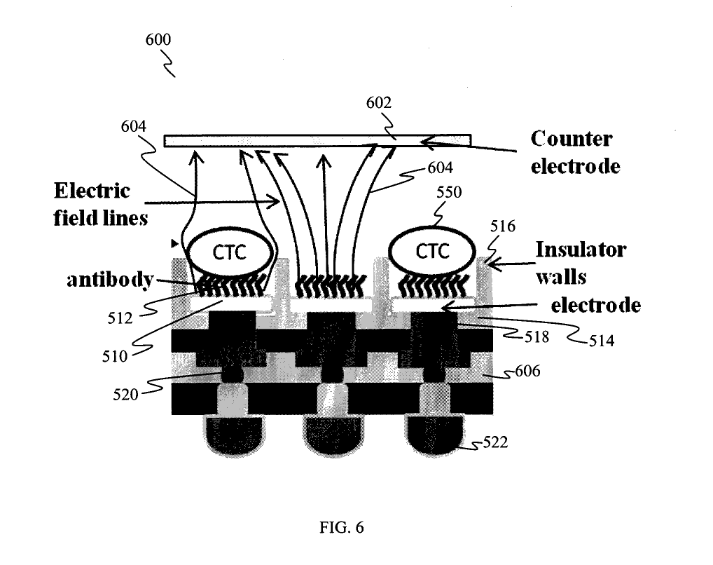

FIG. 6 shows a schematic cross-sectional view of a biosensor 600, during use for detection of cells, according to various embodiments. In the embodiment as shown in FIG. 6, the biosensor 600 includes an underfill layer 606.

FIG. 6 illustrates the position of a counter electrode 602 of the biosensor 600 being disposed out of the plane and/or above the array or plurality of sensing electrodes 510. Such a configuration substantially minimises or avoids the occurrence of the electric field lines, illustrated as arrows (e.g. 604 for two such field lines) in the direction from the sensing electrodes 510 to the counter electrode 602, coupling through the substrate (e.g. the layer of insulation material 514) as well as current escaping from underneath the target cells 550, thereby leading to measurement ambiguity. In further embodiments, the counter electrode 602 may be disposed in the same plane as that of the plurality of sensing electrodes 510. In addition, while not shown, a reference electrode may also be provided in the biosensor 600.

As shown in FIG. 6, the electric field lines 604 are disturbed by the presence of the target cells 550, leading to an increase in impedance. Therefore, the electric field lines 604 originating from a sensing electrode 510 having an immobilised target cell 550 is substantially modified or different from a sensing electrode 510 with no immobilised target cell. The impedance may be obtained by measuring the current and/or voltage between the sensing electrode 510 and the counter electrode 602.

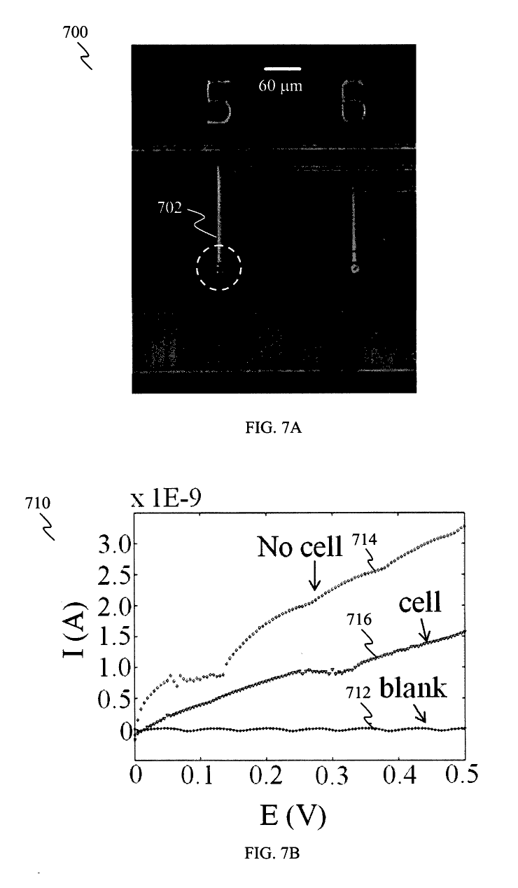

FIG. 7A shows a photograph 700 showing a single cell occupying a sensing electrode, according to various embodiments. The single cell occupies the electrode numbered 5, represented by 702, as highlighted within the dotted circle in the photograph 700. It should be appreciated that the photograph 700 shows a portion of an array of sensing electrodes fabricated for testing purposes to illustrate the capture of a single cell and measurements of the impedance.

FIG. 7B shows a plot 710 of current-voltage measurements, according to various embodiments. As shown in FIG. 7B, no current flows during the “open” state, as represented by 712 for the “open” or “blank” results. The plot 710 further shows that, where an electrical connection is provided between the sensing electrode (i.e. the working electrode) and the counter electrode (i.e. in the “closed” state), the impedance obtained when there is no cell immobilised on a sensing electrode, as represented by 714 for the results, is smaller compared to when there is a cell immobilised on a sensing electrode, as represented by 716 for the results.

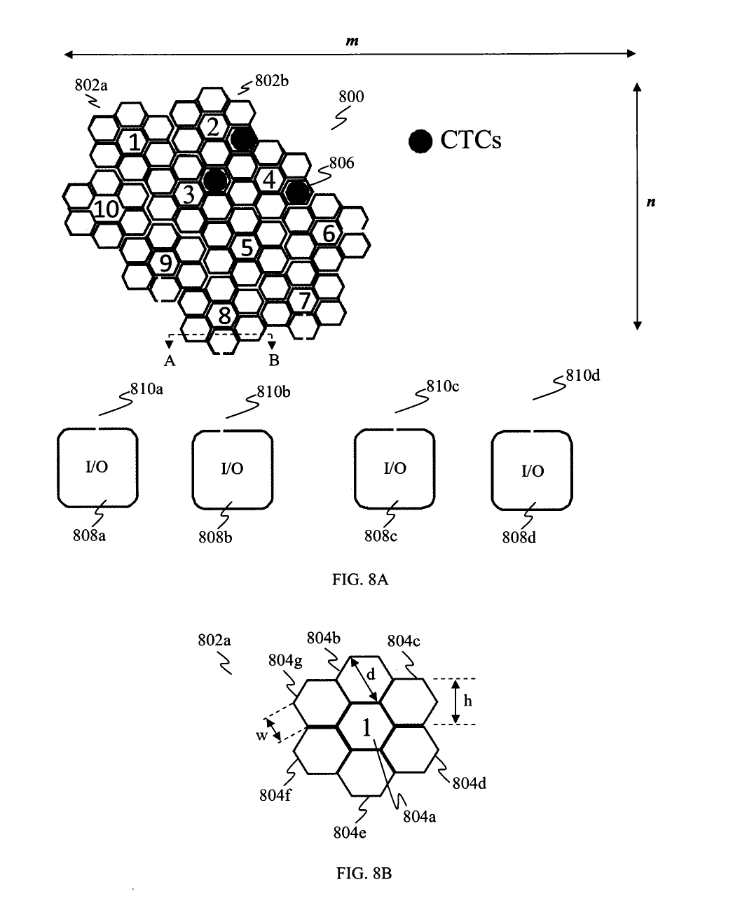

FIG. 8A shows a schematic view of an array of partitioned sensing electrodes 800, according to various embodiments. The sensing electrode array 800 may be provided in the biosensor of various embodiments for single cell detection. The sensing electrode array 800 includes a plurality of sensing electrodes, for example as represented by 802a for sensing electrode 1 and 802b for sensing electrode 2. Each sensing electrode (e.g. 802a, 802b) may be a single contiguous electrode. The sensing electrode array 800 may include m×n number of electrodes, such that the number of electrodes may be in a range of between about 10 and about 500000, for example 50×4 electrodes, 10×60 electrodes, 20×100 electrodes, 50×50 electrodes, 100×50 electrodes, 100×100 electrodes, 100×500 electrodes, 1000×100 electrodes, 120×2500 electrodes or 700×700 electrodes. In various embodiments, m may or may not be equal to n.

Each sensing electrode (e.g. 802a, 802b) may be partitioned into a plurality of sensing electrode segments. As shown in FIG. 8B, the sensing electrode 1 802a is partitioned into 7 sensing electrode segments, including a center sensing electrode segment 804a and a plurality of surrounding sensing electrode segments 804b, 804c, 804d, 804e, 804f, 804g, surrounding the center sensing electrode segment 804a.

As shown in FIGS. 8A and 8B, each sensing electrode (e.g. 802a, 802b) has the shape of a hexagon (i.e. hexagonal configuration), and each sensing electrode segment (e.g. 804a, 804b, 804c) of each sensing electrode (e.g. 802a, 802b) has the shape of a hexagon (i.e. hexagonal configuration), to allow for closest packing density between the sensing electrode segments (e.g. 804a, 804b, 804c) and between the sensing electrodes (e.g. 802a, 802b). However, it should be appreciated that other shapes may be provided, such as but not limited to circle, triangle, square, pentagon, octagon or any polygon or any polygonal shape. In various embodiments, each sensing electrode (e.g. 802a, 802b), and each sensing electrode segment (e.g. 804a, 804b, 804c) of each sensing electrode (e.g. 802a, 802b) may have the same shape or have different shapes, the same size or different sizes, and/or the same dimension or different dimensions.

As shown in FIG. 8B, each sensing electrode segment (e.g. 804a, 804b, 804c) may have a height, h, in a range of between about 50 nm and about 10 microns (μm), a side dimension, d, in a range of between about 50 nm and about 100 μm, and each side of each sensing electrode segment (e.g. 804a, 804b, 804c) may have a width, w, in a range of between about 50 nm and about 100 μm.

Referring to FIG. 8A, each sensing electrode segment of each partitioned sensing electrode (e.g. 802a, 802b) may have a size comparable to the size of the target cell 806 so that a single target cell 806 may be contained, detected and counted in an individual sensing electrode segment.

The sensing electrode array 800 may be electrically coupled to a plurality of input-output ports 808a, 808b, 808c, 808d, via a respective electrical interconnection 810a, 810b, 810c, 810d. In various embodiments, one I/O port may be electrically coupled to one sensing electrode or more than one sensing electrode. Therefore, each I/O port may be electrically coupled to a plurality of sensing electrode segments. Referring to FIG. 8A, the I/O port 808a is coupled to the sensing electrode 9 via the electrical interconnection 810a, the I/O port 808b is coupled to the sensing electrode 8 via the electrical interconnection 810b, the I/O port 808c is coupled to the sensing electrode 7 via the electrical interconnection 810c and the I/O port 808d is coupled to the sensing electrode 6 via the electrical interconnection 810d.

While four I/O ports 808a, 808b, 808c, 808d, are illustrated in FIG. 8A, it should be appreciated that any number of I/O ports may be provided, depending on the number of the plurality of sensing electrodes (e.g. 802a, 802b). For example, the number of I/O ports may be in a range of between about 10 and about 500000.

In various embodiments, partitioning may be achieved by providing an insulation material such as but is not limited to silicon nitride, silicon dioxide or insulating polymers, to partition the sensing electrodes (e.g. 802a, 802b) into sensing electrode segments (e.g. 804a, 804b, 804c). In various embodiments, the insulation material may be provided to form protrusions or walls substantially surrounding each electrode segment (e.g. 804a, 804b, 804c) in order to form a recess having the sensing electrode segment (e.g. 804a, 804b, 804c), such that a single cell may fit in the recess. Therefore, after the flow-through of blood sample, the target cells 806 may be dispersed on the sensing electrode array 800 such that a target cell 806 may fit into a single electrode segment (e.g. 804a, 804b, 804c) with minimal opportunity to settle across partitions of the sensing electrode segment (e.g. 804a, 804b, 804c) due to their size and shape. Once settled into a respective sensing electrode segment (e.g. 804a, 804b, 804c), the target cells 806 may be counted with single cell precision using any available electrical/electrochemical methods such as potentiometry and impedance.

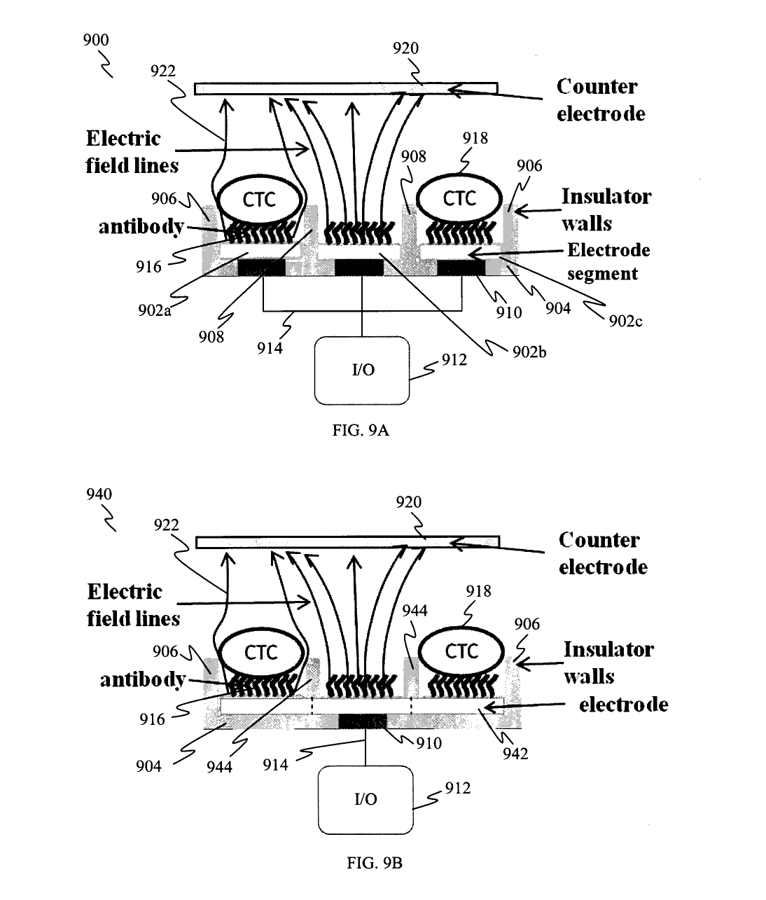

FIGS. 9A and 9B show schematic cross-sectional views of a respective biosensor 900, 940, during use for detection of cells, according to various embodiments. The cross-sectional views of the biosensors 900, 940, may be that taken along the line A-B as shown in FIG. 8A. Therefore, the cross-sectional views relate to a sensing electrode. Similar features as illustrated in FIGS. 9A and 9B are denoted by the same reference numbers and descriptions relating to such features in the context of the biosensor 900 of FIG. 9A may similarly be applicable to the biosensor 940 of FIG. 9B.

Referring to FIG. 9A, the biosensor 900 may include a plurality of sensing electrode segments 902a, 902b, 902c, of a sensing electrode. The sensing electrode with the plurality of sensing electrode segments 902a, 902b, 902c, may be formed on an insulation material (e.g. a layer of insulator or insulation material, e.g. a layer of silicon nitride (Si₃N₄)) 904. The layer of insulation material 904 may be a support substrate of the biosensor 900. The sensing electrode may be electrically isolated from adjacent sensing electrodes by the insulator walls (e.g. an insulation material) 906, while the sensing electrode segments 902a, 902b, 902c, may be electrically isolated from each other by the partition walls (e.g. a further insulation material) 908.

The insulator walls 906 and the partition walls 908 may extend from a surface of the support substrate or the layer of insulation material 904. The insulator walls 906 and the partition walls 908 may be part of the layer of insulation material 904 (i.e. a continuous structure) or may not be part of the layer of insulation material 904, for example being separately formed on the layer of insulation material 904. The insulator walls 906, the partition walls 908 and the layer of insulation material 904 may be of the same insulation material or of different insulation materials. The insulation material may include but is not limited to silicon nitride, silicon dioxide or insulating dielectrics and polymers.

Each sensing electrode segment 902a, 902b, 902c, may be coupled to a respective interconnect portion, as represented by 910 for one such interconnect portion. The respective interconnect portion 910 is in electrical communication with a respective sensing electrode segment 902a, 902b, 902c. The plurality of interconnect portions 910 may be spaced apart, as shown in FIGS. 9A. The plurality of interconnect portions 910 may be formed through the layer of insulation material 904. In various embodiments, the interconnect portions 910 may be in the form of a through via or arranged within a through via, for example by depositing a metal (e.g. gold) within the through via.

The sensing electrode segments 902a, 902b, 902c, may be coupled to an input-output (I/O) port 912 configured for external connections (i.e. connections to external circuits or devices). The I/O port 912 may be coupled to the sensing electrode segments 902a, 902b, 902c, via electrical interconnections 914 to the plurality of interconnect portions 910.

As shown in FIG. 9A, each sensing electrode segment 902a, 902b, 902c, may include an antibody 916 coated on a surface of the sensing electrode segment 902a, 902b, 902c. The antibody 916 may be specific to a particular type of target cells (e.g. CTCs) 918 that are to be detected and counted. Therefore, the target cells 918 may be immobilised or positioned within each of the plurality of sensing electrode segments 902a, 902b, 902c. As each partitioned sensing electrode segment 902a, 902b, 902c, is of a size comparable to that of the target cells 918, a single target cell 918 may be immobilised on each sensing electrode segment 902a, 902b, 902c, as shown in FIG. 9A.

The biosensor 900 may further include a counter electrode 920, positioned out of the plane of the sensing electrode segments 902a, 902b, 902c, and/or above the sensing electrode segments 902a, 902b, 902c. In addition, while not shown, a reference electrode may also be provided in the biosensor 900.

As shown in FIG. 9A, as an example based on the sensing electrode segment 902a, the electric field lines, illustrated as arrows (e.g. 922 for one such field line) in the direction from the sensing electrode segment 902a to the counter electrode 920, may be disturbed by the presence of the target cell 918 immobilised on the sensing electrode segment 902a. The presence of the target cell 918 on the sensing electrode segment 902a may lead to an increase in the impedance measured, compared to that of the sensing electrode segment 902b without an immobilised target cell, where the electric field lines are not disturbed. The impedance may be obtained by measuring the current and/or voltage between the sensing electrode segment 902a and the counter electrode 920.

Referring to FIG. 9B, the biosensor 940 may include a sensing electrode 942 formed on an insulation material (e.g. a layer of insulator or insulation material, e.g. a layer of silicon nitride (Si₃N₄)) 904. The layer of insulation material 904 may be a support substrate of the biosensor 940. The sensing electrode 942 may be electrically isolated from adjacent sensing electrodes by the insulator walls (e.g. an insulation material) 906. The insulator walls 906 may extend from a surface of the support substrate or the layer of insulation material 904.

In various embodiments, the sensing electrode 942 may be partitioned by partition walls (e.g. a further insulation material) 944 formed on the sensing electrode 942, into a plurality of sensing electrode segments. The partition walls 944 may extend from a surface of the sensing electrode 942. As an example and not limitation and based on the illustration in FIG. 9B, the sensing electrode 942 may be partitioned effectively into three sensing electrode segments, with the boundaries of the sensing electrode segments denoted by dotted lines as shown in FIG. 9B. Therefore, the effective sensing electrode segments are partitioned by the partition walls 944 into respective individual recesses acting as respective effective individual sensing electrode segments.

The insulator walls 906 may be part of the layer of insulation material 904 (i.e. a continuous structure) or may not be part of the layer of insulation material 904, for example being separately formed on the layer of insulation material 904. The insulator walls 906, the partition walls 908 and the layer of insulation material 904 may be of the same insulation material or of different insulation materials. The insulation material may include but is not limited to silicon nitride, silicon dioxide or insulating polymers.

The sensing electrode 942 may be coupled to an interconnect portion 910 such that the interconnect portion 910 is in electrical communication with the sensing electrode 942. The interconnect portion 910 may be formed through the layer of insulation material 904. In various embodiments, the interconnect portion 910 may be in the form of a through via or arranged within a through via, for example by depositing a metal (e.g. gold) within the through via.

The sensing electrode 942 may be coupled to an input-output (I/0) port 912 configured for external connections (i.e. connections to external circuits or devices). The I/O port 912 may be coupled to the sensing electrode 942 via an electrical interconnection 914 to the interconnect portion 910.

As each effective partitioned sensing electrode segment, with the corresponding recess formed, is of a size comparable to that of the target cells 918, a single target cell 918 may be immobilised within each recess, on each sensing electrode segment, as shown in FIG. 9B.

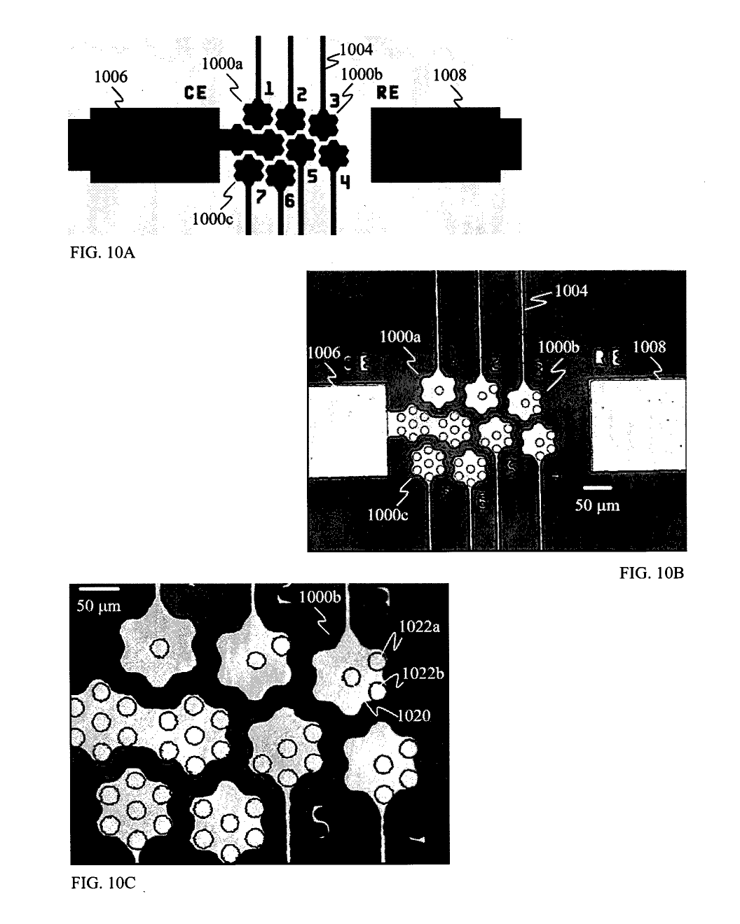

FIG. 10A shows a top view of a design of a plurality of sensing electrodes, according to various embodiments. The plurality of sensing electrodes include seven sensing electrodes numbered from 1 to 7, for example electrode 1 1000a, electrode 3 1000b and electrode 7 1000c. Each sensing electrode may have an interconnection, for example as represented by 1004 for electrode 3 1000b, for example for coupling to an I/O port. As shown in FIG. 10A, each of the plurality of sensing electrodes (e.g. 1000a, 1000b, 1000c) are partitioned into a plurality of sensing electrode segments. The design may also include a counter electrode, CE, 1006 and a reference electrode, RE, 1008.

FIGS. 10B and 10C show optical microscope images of top views of the manufactured plurality of sensing electrodes of the embodiment of FIG. 10A. As shown clearly in FIG. 10C, each sensing electrode may be partitioned into a plurality of sensing electrode segments, where the plurality of sensing electrode segments of each partitioned electrode include a center sensing electrode segment and a plurality of surrounding sensing electrode segments at least substantially surrounding the center sensing electrode segment. As an example, electrode 3 1000b includes a center sensing electrode segment 1020 and two surrounding sensing electrode segments 1022a, 1022b, substantially surrounding the center sensing electrode segment 1020.

As shown in FIGS. 10A and 10B, the counter electrode 1006 and the reference electrode 1008 may be provided on the same plane as the sensing electrodes (e.g. electrode 1 1000a, electrode 3 1000b and electrode 7 1000c).

In the context of various embodiments, the counter electrode (CE) (e.g. 1006) may be located on the same plane as the sensing electrodes (or working electrodes (WE)) or on another plane different from the plane of the sensing electrodes. In various embodiments, the area of the CE may be equal to or up to 100 times larger than the area of the WE.

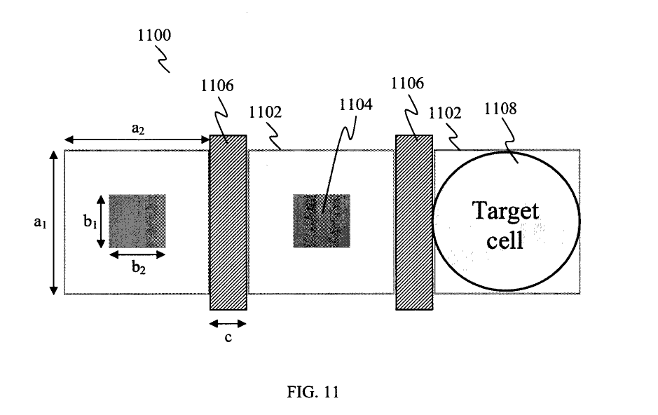

FIG. 11 shows a schematic top view of a plurality or array 1100 of sensing electrodes or sensing electrode segments 1102 of a partitioned electrode, according to various embodiments, which may be provided in the biosensor of various embodiments. Each sensing electrode or sensing electrode segment 1102 may have a square or rectangle shape, and is coupled to an interconnect portion 1104 of a square or rectangle shape. It should be appreciated that the area of the interconnect portion 1104 may be smaller than or equal to the area of the sensing electrode or sensing electrode segment 1102.

Each sensing electrode 1102 may be separated from an adjacent sensing electrode or each sensing electrode segment 1102 may be separated from an adjacent sensing electrode segment by an insulation material 1106, for example in the form of a wall or protrusion, to form respective recesses. Each sensing electrode or sensing electrode segment 1102 may have a size comparable to that of the target cell (e.g. rare cell, e.g. CTC) 1108 such that an individual target cell 1108 may be contained within a recess having a respective sensing electrode or sensing electrode segment 1102.

In various embodiments, each sensing electrode or sensing electrode segment 1102 may have a length, a₁, of between about 50 nm and about 100 μm, for example a range of between about 200 nm and about 50 μm or between about 1 μm and about 30 μm, for example about 25 μm, and a width, a₂, of between about 50 nm and about 100 μm, for example a range of between about 200 nm and about 50 μm or between about 1 μm and about 30 μm, for example about 25 μm. Each interconnect portion 1104 may have a length, b₁, of between about 50 nm and about 100 μm, for example a range of between about 200 nm and about 50 μm or between about 1 μm and about 30 μm, for example about 10 μm and a width, b₂, of between about 50 nm and about 100 μm, for example a range of between about 200 nm and about 50 μm or between about 1 μm and about 30 μm, for example about 10 μm. In various embodiments, a₁=a₂, and/or b₁=b₂, and/or a₁=b₁, and/or a₂=b₂.

In various embodiments, a biosensor may include the plurality or array 1100 of sensing electrodes or sensing electrode segments 1102 of a partitioned electrode in a grid pattern of m×n number of electrodes, such that the number of electrodes may be in a range of between about 10 and about 500000, similar to that as described in the context of the sensing electrode array 800 (FIG. 8A). In various embodiments, m may or may not be equal to n.

In various embodiments, the spacing, c, between adjacent sensing electrodes or sensing electrode segments 1102 (or the thickness of the insulation material 1106) may be in a range of between about 50 nm and about 500 μm, for example a range of between about 200 nm and about 300 μm, between about 1 μm and about 100 μm or between about 1 μm and about 10 μm, for example about 5 μm.

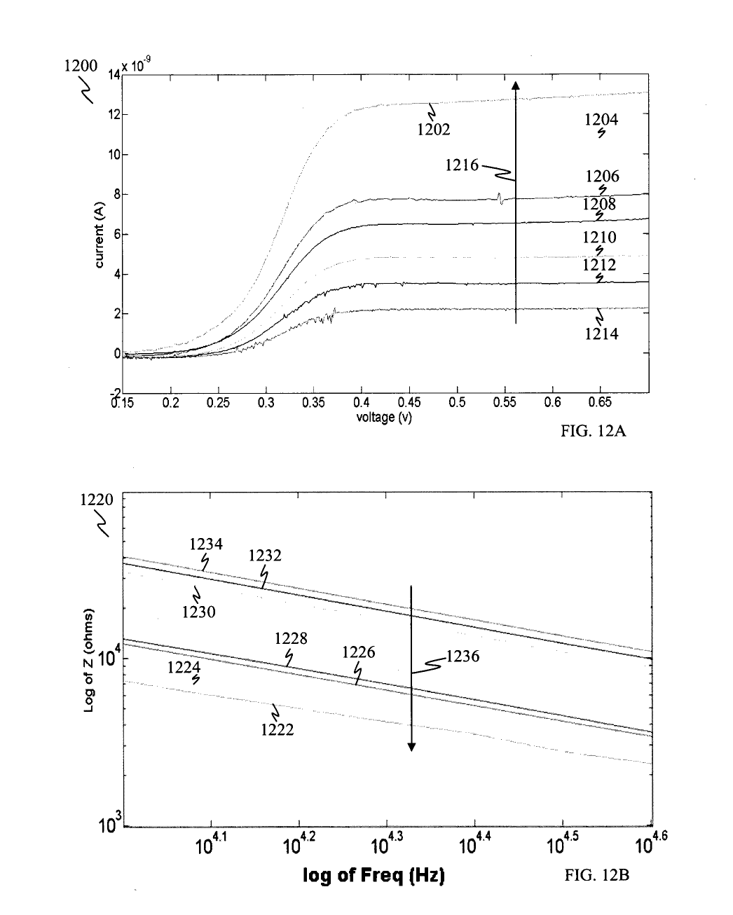

FIG. 12A shows a plot 1200 of cyclic voltammetry measurements, according to various embodiments, while FIG. 12B shows a plot of impedance measurements, according to various embodiments. The measurements are obtained by partial blocking of the sensing electrode segments of the embodiments of FIG. 10A to 10C.

As an example and not limitation, the partitioned hexagonal sensing electrode 7 1000c, including seven sensing electrode segments, of FIGS. 10A to 10C is used to demonstrate that the partitioned electrode array may respond to the presence or absence of target cells. Each sensing electrode segment may be successively closed off to simulate the condition when a target cell occupies the respective sensing electrode segment (i.e. a target cell is captured in a respective sensing electrode segment). FIGS. 12A and 12B show the results 1202 (FIG. 12A), 1222 (FIG. 12B) for absence of target cells (i.e. no target cell is captured in any of the sensing electrode segment), the results 1204 (FIG. 12A), 1224 (FIG. 12B) for a target cell captured in one sensing electrode segment, the results 1206 (FIG. 12A), 1226 (FIG. 12B) for target cells captured in two sensing electrode segments, the results 1208 (FIG. 12A), 1228 (FIG. 12B) for target cells captured in three sensing electrode segments, the results 1210 (FIG. 12A), 1230 (FIG. 12B) for target cells captured in four sensing electrode segments, the results 1212 (FIG. 12A), 1232 (FIG. 12B) for target cells captured in five sensing electrode segments and the results 1214 (FIG. 12A), 1234 (FIG. 12B) for target cells captured in six sensing electrode segments. The arrows 1216 (FIG. 12A), 1236 (FIG. 12B) show the results in the direction of decreasing number of captured target cells. It should be appreciated that the distinctions between the different results for the different cell occupancy as illustrated in FIGS. 12A and 12B may be enhanced by forming well-defined lithography patterns to define the sensing electrode segments.

FIG. 12A shows that the current response decreases as the number of target cells occupying the sensing electrode segments increases, resulting in a reduced electrode area available for electrochemical reactions. FIG. 12B shows that the impedance response is inverse to that of the cyclic voltammetry measurements of FIG. 12A, that is the impedance increases as the number of target cells occupying the sensing electrode segments increases.

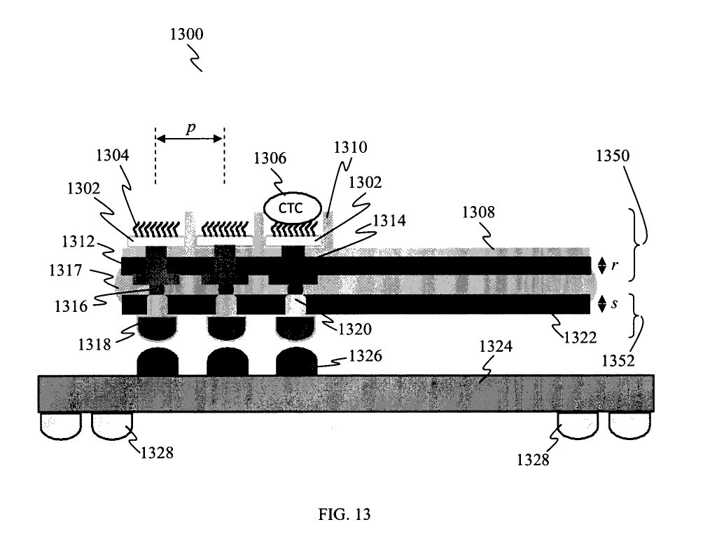

In various embodiments, for very large electrode arrays (e.g. having thousands of electrodes), the sectioned or partitioned electrode array may be combined with through vias (e.g. TSVs) to achieve the necessary array size and density. FIG. 13 shows a schematic cross-sectional view of a biosensor 1300 including a partitioned electrode and through vias, according to various embodiments. For clarity purposes, only three sensing electrode segments are illustrated, with their corresponding features (e.g. through vias, solder bumps).

The biosensor 1300 may include a high density array or plurality of sensing electrode segments, as represented by 1302 for two sensing electrode segments. The plurality of sensing electrode segments 1302 may have a hexagonal configuration such as the embodiments of FIGS. 8A and 8B or a square configuration such as the embodiment of FIG. 11. The plurality of sensing electrode segments 1302 may have a pitch, p, of about 30 μm between adjacent sensing electrode segments 1302. However, it should be appreciated that the pitch, p, may be in a range of between about 1 μm and about 500 μm.

The plurality of sensing electrode segments 1302 may be made of gold (Au). Each sensing electrode segment 1302 may include an antibody 1304 coated on a surface of the sensing electrode segment 1302 for capturing or immobilising a target cell (e.g. CTC) 1306.

Each sensing electrode segment 1302 may have a size comparable to that of the target cell 1306 being detected. Each individual sensing electrode segment 1302 may form a respective working electrode, which may be used individually or in groups or clusters with electronic addressing schemes.

The biosensor 1300 may further include a counter electrode (not shown) positioned out of the plane and above the plurality of sensing electrode segments 1302. The counter electrode may be made of noble metal or indium titanium oxide. In addition to the counter electrode, a reference electrode (not shown) may also be provided.

The plurality of sensing electrode segments 1302 may be formed on an insulation material (e.g. a layer of insulator or insulation material, e.g. a layer of silicon nitride (Si₃N₄)) 1308, with partition walls 1310, as part of the layer of insulation material 1308 or formed separately on the layer of insulation material 1308, being provided between adjacent sensing electrode segments 1302. The partition walls 1310 may provide electrical isolation between adjacent sensing electrode segments 1302. The layer of insulation material 1308 may be a support substrate of the biosensor 1300.

In various embodiments, the layer of insulation material 1308 may have a thickness in a range of between about 0.1 μm and about 10 μm.

In various embodiments, the layer of insulation material 1308 may be provided on a layer 1312, for example a layer of interposer, having a thickness, r, of about 50 μm. However, it should be appreciated that the layer of interposer 1312 may have any thickness in a range of between about 25 μm and about 500 μm.

The biosensor 1300 may include a plurality of through vias, as represented by 1314 for one through via, coupled to the plurality of sensing electrode segments 1302. The plurality of through vias 1314 may be spaced apart, as shown in FIG. 13, corresponding to the plurality of sensing electrode segments 1302. The plurality of through vias 1314 may be formed through the insulation material layer 1308 and the interposer layer 1312.

An interconnect portion may be provided or arranged within each through via 1314, for example by depositing a metal (e.g. gold) within each through via 1314, such that a respective through via 1314 with the interconnect portion, may be in electrical communication with a respective sensing electrode segment 1302. Therefore, a plurality of interconnect portions may be provided, which may allow for coupling to external connections.

In various embodiments, each through via 1314 may be provided with a solder bump 1316. The solder bumps 1316 may be provided in a layer 1317, for example an underfill layer. In various embodiments, the underfill layer 1317 may have a thickness in a range of between about 10 μm and about 500 μm, for example a range of between about 50 μm and about 300 μm or between about 100 μm and about 200 μm,.

In various embodiments, each solder bump 1316 may be electrically coupled to a flipchip bump 1318 through a respective through via 1320 formed through a layer 1322, for example another interposer layer. In various embodiments, the interposer layer 1322 may have a thickness, s, of about 100 However, it should be appreciated that the layer of interposer 1322 may have any thickness in a range of between about 25 μm and about 500 μm for example a range of between about 50 μm and about 300 μm or between about 100 μm and about 200 μm. In various embodiments, the layer of interposer 1322 may include electronic circuits built in or integrated for the purpose of electrical measurements.

In addition, it should be appreciated that the biosensor 1300 may include a plurality of interposer layers comprising various electrical circuits.

In various embodiments, the biosensor 1300 may be coupled to a ball grid array (BGA) 1324 for connection to, for example, integrated circuits or external connections. The BGA 1324 may include a plurality of solder balls 1326 on one surface of the BGA 1324 for coupling to the respective flipchip bump 1318. The BGA 1324 further includes a plurality of solder balls 1328 on another surface of the BGA 1324 for coupling to integrated circuits or external connections.

In further embodiments, the layer 1312 may be a decoder and the layer 1322 may be an impedance IC, thereby providing a biosensor 1300 with a 3D integrated high density electrode array with built-in or integrated ICs for measurements.

In further embodiments, the layer 1317 may be a printed circuit board (PCB), which may include integrated ICs for detection, data processing and/or data transfer. The solder bumps 1316 may not be necessary as each through via 1314 may be electrically coupled to the PCB 1317 and each through via 1320 may be electrically coupled to the PCB 1317.

In the context of various embodiments, the biosensor may be made up of two chips, for example a first chip as represented by 1350, and a second chip, as represented by 1352. The first chip 1350 may include the plurality of sensing electrode segments 1302, the layer of insulation material 1308, with partition walls 1310, the layer 1312 and the plurality of through vias 1314 while the second chip 1352 may include the plurality of flipchip bumps 1318, the plurality of through vias 1320 and the layer 1322.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A biosensor, comprising:
a support substrate;
a plurality of sensing electrodes arranged on the support substrate, each of the plurality of sensing electrodes comprises a plurality of sensing electrode segments laterally disposed from each other, wherein each of the plurality of sensing electrode segments is adapted for counting of an individual target molecule at a resolution of a single target molecule; and
a plurality of input-output ports configured for external connection;
wherein each of the plurality of sensing electrodes is electrically isolated from each other and respectively coupled to each of the plurality of input-output ports.

2. The biosensor of claim 1, wherein the support substrate comprises a plurality of through vias arranged spaced apart from each other.

3. The biosensor of claim 2, further comprising a plurality of interconnect portions, each of the plurality of interconnect portions is arranged within each of the plurality of through vias.

4. The biosensor of claim 3, wherein each of the plurality of sensing electrode segments is electrically coupled to each of the plurality of interconnect portions.

5. The biosensor of claim 1, wherein each of the plurality of sensing electrode segments is shaped to trap an individual target molecule.

6. The biosensor of claim 1, wherein each of the plurality of sensing electrode segments is dimensioned to provide space for an individual target molecule.

7-8. (canceled)

9. The biosensor of claim 1, wherein the plurality of sensing electrode segments comprise a center sensing electrode segment and a plurality of surrounding sensing electrode segments configured to surround the center sensing electrode segment.

10. The biosensor of claim 1, further comprising a counter electrode disposed above or in the same plane as that of the plurality of sensing electrodes, such that when a voltage is applied between the plurality of sensing electrodes and the counter electrode, an electric field is created therewithin to allow the counting of individual target molecule.

11. The biosensor of claim 1, wherein an insulation material is provided between each of the plurality of sensing electrodes.

12. The biosensor of claim 1, wherein a further insulation material is provided between each of the plurality of sensing electrode segments.

13. (canceled)

14. The biosensor of claim 12, wherein the further insulation material extends from a surface of the support substrate or from a surface of each of the plurality of sensing electrodes such that an individual target molecule is positioned within each of the plurality of sensing electrode segments.

15-28. (canceled)

29. A biosensor, comprising:
a support substrate, the support substrate comprising a plurality of through vias arranged spaced apart from each other;
a plurality of interconnect portions, each of the plurality of interconnect portions arranged within each of the plurality of through vias; and
a plurality of sensing electrodes arranged on the support substrate, wherein each of the plurality of sensing electrodes is adapted for counting of an individual target molecule at a resolution of a single target molecule;
wherein each of the plurality of sensing electrodes is electrically isolated from each other and respectively coupled to external connection via each of the plurality of interconnect portions.

30. The biosensor of claim 29, further comprising a plurality of input-output ports configured for the external connection, wherein each of the plurality of sensing electrodes is respectively coupled to each of the plurality of input-output ports.

31. (canceled)

32. The biosensor of claim 29, wherein each of the plurality of sensing electrodes comprises a plurality of sensing electrode segments laterally disposed from each other.

33. The biosensor of claim 32, wherein a further insulation material is provided between each of the plurality of sensing electrode segments.

34-37. (canceled)

38. The biosensor of claim 33, wherein the further insulation material extends from a surface of the support substrate or from a surface of each of the plurality of sensing electrodes such that an individual target molecule is positioned within each of the plurality of sensing electrode segments.

39-41. (canceled)

42. The biosensor of claim 32, wherein each of the plurality of sensing electrodes or each of the plurality of sensing electrode segments is dimensioned to provide space for an individual target molecule.

43-53. (canceled)

54. The biosensor of claim 1, further comprising a chamber housing formed over the support substrate, the chamber housing having an inlet and an outlet.

55. The biosensor of claim 54, further comprising a movable magnet arranged over the chamber housing.

56. The biosensor of claim 54, further comprising a filter disposed on a surface of the chamber housing spaced apart from the support substrate.

57-58. (canceled)
